(19) United States
(12) Patent Application Publication
(10) Pub. No.: US 2025/0184103 A1
(43) Pub. Date: Jun. 5, 2025

(54) BEAM-BASED FULL-DUPLEX CONFIGURATIONS

(71) Applicant: QUALCOMM Incorporated, San Diego, CA (US)

(72) Inventors: Qian ZHANG, Basking Ridge, NJ (US); Navid ABEDINI, Basking Ridge, NJ (US); Junyi LI, Fairless Hills, PA (US); Tao LUO, San Diego, CA (US)

(21) Appl. No.: 18/525,137

(22) Filed: Nov. 30, 2023

(51) Int. Cl. H04L 5/14; H04W 72/044

(52) U.S. Cl. CPC H04L 5/14; H04W 72/044

(57) ABSTRACT

Methods, systems, and devices for wireless communications are described. A network entity may identify a subset of communication parameters for which a full-duplex configuration is applicable for a wireless communication between a user equipment (UE) and the network entity. The UE may receive an indication of the full-duplex configuration and the subset of communication parameters and determine whether to use the full-duplex configuration or another configuration based on whether a communication parameter of the wireless communication is included in the subset of communication parameters. Alternatively, the network entity may identify multiple full-duplex configurations and respective subsets of communication parameters for which each full-duplex configuration is applicable. The UE may receive an indication of the multiple full-duplex configurations and the respective subsets of communication parameters and identify a first full-duplex configuration based on the communication parameter being included in a first subset of communication parameters corresponding to the first full-duplex configuration.

### TECHNICAL FIELD

The following relates to wireless communications, including beam-based full-duplex configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support beam-based full-duplex configurations. In one example, the described techniques provide for a network entity to identify a subset of communication parameters for which a full-duplex configuration is applicable for a wireless communication between a user equipment (UE) and the network entity. In such examples, the UE may receive a control signal indicating the full-duplex configuration and the subset of communication parameters. The UE may determine whether to use the full-duplex configuration or another configuration (e.g., half-duplex configuration) based on whether a communication parameter of the wireless communication is included in the subset of communication parameters associated with the full-duplex configuration. In another example, the network entity may identify multiple full-duplex configurations and identify respective subsets of communication parameters for which each full-duplex configuration is applicable for a wireless communication between the UE and the network entity. The UE may receive a control signal indicating the multiple full-duplex configurations and the respective subsets of communication parameters. Accordingly, the UE may identify a first full-duplex configuration based on the communication parameter being included in a first subset of communication parameters corresponding to the first full-duplex configuration. Based on the determining the configuration, the UE and the network entity may communicate.

A method for wireless communications by a UE is described. The method may include receiving a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity, determining whether to use the full-duplex configuration or another configuration for wireless communication with the network entity based on a communication parameter associated with the wireless communication and the subset of communication parameters associated with the full-duplex configuration, and communicating with the network entity in accordance with the communication parameter and based on the determining.

A UE for wireless communications is described. The UE may include one or more memories storing processor executable code, and one or more processors coupled (e.g., operatively, communicatively, functionally, electronically, or electrically) with the one or more memories. The one or more processors may individually or collectively operable to execute the code (e.g., directly, indirectly, after pre-processing, without pre-processing) to cause the UE to receive a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity, determine whether to use the full-duplex configuration or another configuration for wireless communication with the network entity based on a communication parameter associated with the wireless communication and the subset of communication parameters associated with the full-duplex configuration, and communicate with the network entity in accordance with the communication parameter and based on the determining.

Another UE for wireless communications is described. The UE may include means for receiving a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity, means for determining whether to use the full-duplex configuration or another configuration for wireless communication with the network entity based on a communication parameter associated with the wireless communication and the subset of communication parameters associated with the full-duplex configuration, and means for communicating with the network entity in accordance with the communication parameter and based on the determining.

A non-transitory computer-readable medium storing code for wireless communications is described. The code may include instructions executable by one or more processors (e.g., directly, indirectly, after pre-processing, without pre-processing) to receive a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity, determine whether to use the full-duplex configuration or another configuration for wireless communication with the network entity based on a communication parameter associated with the wireless communication and the subset of communication parameters associated with the full-duplex configuration, and communicate with the network entity in accordance with the communication parameter and based on the determining.

Some examples of the method, UEs, and non-transitory computer-readable medium described herein may further include operations, features, means, or instructions for receiving a signal including an indication to use the other configuration based on the communication parameter being excluded from the subset of communication parameters, where communicating with the network entity may be based on the other configuration.

Some examples of the method, UEs, and non-transitory computer-readable medium described herein may further include operations, features, means, or instructions for dropping the full-duplex configuration based on the indication to use the other configuration.

In some examples of the method, UEs, and non-transitory computer-readable medium described herein, the signal includes one of downlink control information (DCI), a radio resource control (RRC) message, or a medium access control-control element (MAC-CE).

In some examples of the method, UEs, and non-transitory computer-readable medium described herein, the determining may include operations, features, means, or instructions for determining to use the other configuration based on the communication parameter being excluded from the subset of communication parameters, where communicating with the network entity may be based on the other configuration.

Some examples of the method, UEs, and non-transitory computer-readable medium described herein may further include operations, features, means, or instructions for dropping the full-duplex configuration based on the communication parameter being excluded from the subset of communication parameters.

In some examples of the method, UEs, and non-transitory computer-readable medium described herein, the determining may include operations, features, means, or instructions for determining to use the full-duplex configuration for the wireless communication based on the communication parameter being included in the subset of communication parameters, where communicating with the network entity may be based on the full-duplex configuration.

Some examples of the method, UEs, and non-transitory computer-readable medium described herein may further include operations, features, means, or instructions for determining that the time and frequency resources of the full-duplex configuration at least partially overlap with one or more channels, one or more reference signals, or any combination thereof, where determining whether to use the full-duplex configuration or the other configuration may be further based on the time and frequency resources at least partially overlapping with the one or more channels, the one or more reference signals, or any combination thereof.

Some examples of the method, UEs, and non-transitory computer-readable medium described herein may further include operations, features, means, or instructions for dropping the full-duplex configuration based on the time and frequency resources at least partially overlapping with the one or more channels, the one or more reference signals, or any combination thereof, where communicating with the network entity may be based on the other configuration.

Some examples of the method, UEs, and non-transitory computer-readable medium described herein may further include operations, features, means, or instructions for receiving a signal including an indication to use the other configuration based on the time and frequency resources at least partially overlapping with the one or more channels, the one or more reference signals, or any combination thereof and dropping the full-duplex configuration based on the indication to use the other configuration, where communicating with the network entity may be based on the other configuration.

In some examples of the method, UEs, and non-transitory computer-readable medium described herein, the signal including the indication may be a second control signal configuring the one or more channels, a third control signal configuring the one or more reference signals, or any combination thereof.

In some examples of the method, UEs, and non-transitory computer-readable medium described herein, the one or more channels include a random access channel (RACH), a remaining minimum system information (RMSI) physical downlink control channel (PDCCH), an RMSI physical downlink shared channel (PDSCH), a paging PDCCH, a paging PDSCH, or any combination thereof.

In some examples of the method, UEs, and non-transitory computer-readable medium described herein, the UE may be operating in a RRC inactive mode or a RRC idle mode, and the control signal includes a system information signal.

In some examples of the method, UEs, and non-transitory computer-readable medium described herein, the UE may be operating in a RRC active mode, and the control signal includes a RRC message.

In some examples of the method, UEs, and non-transitory computer-readable medium described herein, the communication parameter includes one or more beams, one or more signal thresholds associated with the one or more beams, a beam direction of the wireless communication, a geographic location of the UE, a downlink reception timing, an uplink transmission timing, a round-trip-time (RTT) of the wireless communication, one or more timing advance group (TAG) identifiers, a type of communication link between the UE and the network entity, one or more outputs of a machine learning model, or any combination thereof.

In some examples of the method, UEs, and non-transitory computer-readable medium described herein, the beam direction of the wireless communication may be associated with a synchronization signal block index, a downlink transmission configuration indicator state, an uplink transmission configuration indicator state, spatial relationship of one or more communication beams, or a combination thereof.

In some examples of the method, UEs, and non-transitory computer-readable medium described herein, the set of communication parameters include a set of zones and the method, apparatuses, and non-transitory computer-readable medium may include further operations, features, means, or instructions for receiving an indication that the UE may be operating within a first zone of the set of zones, where determining whether to use the full-duplex configuration or the other configuration for the wireless communication may be based on the indication that the UE may be operating within the first zone.

In some examples of the method, UEs, and non-transitory computer-readable medium described herein, the communication parameter includes a directional beam and the method, apparatuses, and non-transitory computer-readable medium may include further operations, features, means, or instructions for receiving a signal including an indication to use the other configuration based on the directional beam being excluded from a subset of directional beams associated with the full-duplex configuration and dropping the full-duplex configuration based on the indication to use the other configuration, where communicating with the network entity may be via the directional beam and based on the other configuration.

In some examples of the method, UEs, and non-transitory computer-readable medium described herein, the communication parameter includes a directional beam and the method, apparatuses, and non-transitory computer-readable medium may include further operations, features, means, or instructions for determining to use the other configuration based on the directional beam being excluded from a subset of directional beams associated with the full-duplex configuration and dropping the full-duplex configuration based on the directional beam being excluded from the subset of directional beams, where communicating with the network entity may be via the directional beam and based on the other configuration.

Some examples of the method, UEs, and non-transitory computer-readable medium described herein may further include operations, features, means, or instructions for determining that a wireless repeater or a reconfigurable intelligent surface (RIS), or both, may be associated with the communication link between the UE and the network entity, where determining to use the other configuration may be based on the wireless repeater or the RIS, or both, being associated with the communication link.

In some examples of the method, UEs, and non-transitory computer-readable medium described herein, the time and frequency resources associated with the full-duplex configuration include one or more subbands allocated for downlink communications and one or more subbands allocated for uplink communications.

In some examples of the method, UEs, and non-transitory computer-readable medium described herein, the communication parameter may be excluded from the subset of communication parameters based on a wireless repeater or a RIS, or both, being associated with the communication link between the UE and the network entity and determining whether to use the full-duplex configuration or the other configuration may be based on the wireless repeater or the RIS, or both, being associated with the communication link between the UE and the network entity.

A method for wireless communications by a UE is described. The method may include receiving a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity, identifying, from the set of multiple full-duplex configurations, a first full-duplex configuration for wireless communication with the network entity based on a communication parameter associated with the wireless communication being included in a first subset of communication parameters corresponding to the first full-duplex configuration, and communicating with the network entity in accordance with the communication parameter and based on the first full-duplex configuration or another configuration.

A UE for wireless communications is described. The UE may include one or more memories storing processor executable code, and one or more processors coupled (e.g., operatively, communicatively, functionally, electronically, or electrically) with the one or more memories. The one or more processors may individually or collectively operable to execute the code (e.g., directly, indirectly, after pre-processing, without pre-processing) to cause the UE to receive a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity, identify, from the set of multiple full-duplex configurations, a first full-duplex configuration for wireless communication with the network entity based on a communication parameter associated with the wireless communication being included in a first subset of communication parameters corresponding to the first full-duplex configuration, and communicate with the network entity in accordance with the communication parameter and based on the first full-duplex configuration or another configuration.

Another UE for wireless communications is described. The UE may include means for receiving a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity, means for identifying, from the set of multiple full-duplex configurations, a first full-duplex configuration for wireless communication with the network entity based on a communication parameter associated with the wireless communication being included in a first subset of communication parameters corresponding to the first full-duplex configuration, and means for communicating with the network entity in accordance with the communication parameter and based on the first full-duplex configuration or another configuration.

A non-transitory computer-readable medium storing code for wireless communications is described. The code may include instructions executable by one or more processors (e.g., directly, indirectly, after pre-processing, without pre-processing) to receive a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity, identify, from the set of multiple full-duplex configurations, a first full-duplex configuration for wireless communication with the network entity based on a communication parameter associated with the wireless communication being included in a first subset of communication parameters corresponding to the first full-duplex configuration, and communicate with the network entity in accordance with the communication parameter and based on the first full-duplex configuration or another configuration.

Some examples of the method, UEs, and non-transitory computer-readable medium described herein may further include operations, features, means, or instructions for receiving a signal including an indication to use the first full-duplex configuration based on the communication parameter associated with the wireless communication being included in the first subset of communication parameters, where identifying the first full-duplex configuration may be based on the indication to use the first full-duplex configuration.

In some examples of the method, UEs, and non-transitory computer-readable medium described herein, the signal includes an index of the first full-duplex configuration, an identifier associated with the first full-duplex configuration, or both.

In some examples of the method, UEs, and non-transitory computer-readable medium described herein, the signal may be one of a RRC message, DCI, or a MAC-CE.

Some examples of the method, UEs, and non-transitory computer-readable medium described herein may further include operations, features, means, or instructions for determining that the respective time and frequency resources of the first full-duplex configuration at least partially overlap with one or more channels, one or more reference signals, or any combination thereof and determining whether to use the first full-duplex configuration or the other configuration based on the respective time and frequency resources at least partially overlapping with the one or more channels, the one or more reference signals, or any combination thereof.

Some examples of the method, UEs, and non-transitory computer-readable medium described herein may further include operations, features, means, or instructions for dropping the first full-duplex configuration based on the respective time and frequency resources at least partially overlapping with the one or more channels, the one or more reference signals, or any combination thereof, where communicating with the network entity may be based on the other configuration.

Some examples of the method, UEs, and non-transitory computer-readable medium described herein may further include operations, features, means, or instructions for receiving a signal including an indication to use the other configuration based on the respective time and frequency resources at least partially overlapping with the one or more channels, the one or more reference signals, or any combination thereof and dropping the first full-duplex configuration based on the indication to use the other configuration, where communicating with the network entity may be based on the other configuration.

In some examples of the method, UEs, and non-transitory computer-readable medium described herein, the signal including the indication may be a second control signal configuring the one or more channels, a third control signal configuring the one or more reference signals, or any combination thereof.

In some examples of the method, UEs, and non-transitory computer-readable medium described herein, the one or more channels include a RACH, a RMSI PDCCH, an RMSI PDSCH, a paging PDCCH, a paging PDSCH, or any combination thereof.

In some examples of the method, UEs, and non-transitory computer-readable medium described herein, the UE may be operating in a RRC inactive mode or a RRC idle mode, and the control signal includes a system information block.

In some examples of the method, UEs, and non-transitory computer-readable medium described herein, the UE may be operating in a RRC active mode, and the control signal includes a RRC message.

In some examples of the method, UEs, and non-transitory computer-readable medium described herein, the communication parameter includes one or more beams, one or more signal thresholds associated with the one or more beams, a beam direction of the wireless communication, a geographic location of the UE, a downlink reception timing, an uplink transmission timing, a RTT of the wireless communication, one or more TAG identifiers, a type of communication link between the UE and the network entity, one or more outputs of a machine learning model, or any combination thereof.

In some examples of the method, UEs, and non-transitory computer-readable medium described herein, the beam direction of the wireless communication may be associated with a synchronization signal block index, a downlink transmission configuration indicator state, an uplink transmission configuration indicator state, a spatial relations of one or more communication beams, or a combination thereof.

In some examples of the method, UEs, and non-transitory computer-readable medium described herein, the set of communication parameters include a set of zones and the method, apparatuses, and non-transitory computer-readable medium may include further operations, features, means, or instructions for receiving an indication that the UE may be operating within a first zone of the set of zones, where determining whether to use the first full-duplex configuration or the other configuration for the wireless communication may be based on the indication.

In some examples of the method, UEs, and non-transitory computer-readable medium described herein, the communication parameter includes a directional beam and the method, apparatuses, and non-transitory computer-readable medium may include further operations, features, means, or instructions for receiving a signal including an indication to use the first full-duplex configuration based on the directional beam being included in a subset of directional beams associated with the first full-duplex configuration, where communicating with the network entity may be via the directional beam and based on the first full-duplex configuration.

In some examples of the method, UEs, and non-transitory computer-readable medium described herein, the communication parameter includes a directional beam and the method, apparatuses, and non-transitory computer-readable medium may include further operations, features, means, or instructions for determining to use the first full-duplex configuration based on the directional beam being included in a subset of directional beams associated with the first full-duplex configuration, where communicating with the network entity may be via the directional beam and based on the first full-duplex configuration.

Some examples of the method, UEs, and non-transitory computer-readable medium described herein may further include operations, features, means, or instructions for determining that a wireless repeater or a RIS, or both, may be associated with the communication link between the UE and the network entity, where determining to use the first full-duplex configuration may be based on the wireless repeater or the RIS, or both, being associated with the communication link.

In some examples of the method, UEs, and non-transitory computer-readable medium described herein, the time and frequency resources associated with the full-duplex configuration include one or more subbands allocated for downlink communications and one or more subbands allocated for uplink communications.

A method for wireless communications by a network entity is described. The method may include identifying a subset of communication parameters for which a full-duplex configuration is applicable for wireless communication between a UE and the network entity, the subset of communication parameters being from a set of communication parameters respectively associated with a communication link between the UE and the network entity, outputting a control signal indicating the full-duplex configuration and the subset of communication parameters, where the full-duplex configuration indicates time and frequency resources for full-duplex communications, and communicating with the UE in accordance with a communication parameter associated with the wireless communication and based on the full-duplex configuration or another configuration.

A network entity for wireless communications is described. The network entity may include one or more memories storing processor executable code, and one or more processors coupled (e.g., operatively, communicatively, functionally, electronically, or electrically) with the one or more memories. The one or more processors may individually or collectively operable to execute the code (e.g., directly, indirectly, after pre-processing, without pre-processing) to cause the network entity to identify a subset of communication parameters for which a full-duplex configuration is applicable for wireless communication between a UE and the network entity, the subset of communication parameters being from a set of communication parameters respectively associated with a communication link between the UE and the network entity, output a control signal indicating the full-duplex configuration and the subset of communication parameters, where the full-duplex configuration indicates time and frequency resources for full-duplex communications, and communicate with the UE in accordance with a communication parameter associated with the wireless communication and based on the full-duplex configuration or another configuration.

Another network entity for wireless communications is described. The network entity may include means for identifying a subset of communication parameters for which a full-duplex configuration is applicable for wireless communication between a UE and the network entity, the subset of communication parameters being from a set of communication parameters respectively associated with a communication link between the UE and the network entity, means for outputting a control signal indicating the full-duplex configuration and the subset of communication parameters, where the full-duplex configuration indicates time and frequency resources for full-duplex communications, and means for communicating with the UE in accordance with a communication parameter associated with the wireless communication and based on the full-duplex configuration or another configuration.

A non-transitory computer-readable medium storing code for wireless communications is described. The code may include instructions executable by one or more processors (e.g., directly, indirectly, after pre-processing, without pre-processing) to identify a subset of communication parameters for which a full-duplex configuration is applicable for wireless communication between a UE and the network entity, the subset of communication parameters being from a set of communication parameters respectively associated with a communication link between the UE and the network entity, output a control signal indicating the full-duplex configuration and the subset of communication parameters, where the full-duplex configuration indicates time and frequency resources for full-duplex communications, and communicate with the UE in accordance with a communication parameter associated with the wireless communication and based on the full-duplex configuration or another configuration.

Some examples of the method, network entities, and non-transitory computer-readable medium described herein may further include operations, features, means, or instructions for outputting a signal including an indication for the UE to use the other configuration based on the communication parameter being excluded from the subset of communication parameters, where communicating with the UE may be based on the other configuration.

In some examples of the method, network entities, and non-transitory computer-readable medium described herein, the signal may be one of DCI, a RRC message, or MAC-CE.

In some examples of the method, network entities, and non-transitory computer-readable medium described herein, the communicating may include operations, features, means, or instructions for communicating with the UE according to the full-duplex configuration based on the communication parameter being included in the subset of communication parameters.

In some examples of the method, network entities, and non-transitory computer-readable medium described herein, the communicating may include operations, features, means, or instructions for communicating with the UE according to the other configuration based on the time and frequency resources of the full-duplex configuration at least partially overlapping with one or more channels, one or more reference signals, or any combination thereof.

Some examples of the method, network entities, and non-transitory computer-readable medium described herein may further include operations, features, means, or instructions for outputting a signal including an indication to use the other configuration based on the time and frequency resources of the full-duplex configuration at least partially overlapping with the one or more channels, the one or more reference signals, or any combination thereof.

In some examples of the method, network entities, and non-transitory computer-readable medium described herein, the signal including the indication may be a second control signal configuring the one or more channels, a third control signal configuring the one or more reference signals, or any combination thereof.

In some examples of the method, network entities, and non-transitory computer-readable medium described herein, the one or more channels include a RACH, a RMSI PDCCH, an RMSI PDSCH, a paging PDCCH, a paging PDSCH, or any combination thereof.

In some examples of the method, network entities, and non-transitory computer-readable medium described herein, the UE may be operating in a RRC inactive mode or a RRC idle mode, and the control signal includes a system information signal.

In some examples of the method, network entities, and non-transitory computer-readable medium described herein, the UE may be operating in a RRC active mode, and the control signal includes a RRC message.

In some examples of the method, network entities, and non-transitory computer-readable medium described herein, the communication parameter includes one or more beams, one or more signal threshold associated with the one or more beams, a beam direction of the wireless communication, a geographic location of the UE, a downlink reception timing, an uplink transmission timing, a RTT of the wireless communication, one or more TAG identifiers, a type of communication link between the UE and the network entity, one or more outputs of a machine learning model, or any combination thereof.

In some examples of the method, network entities, and non-transitory computer-readable medium described herein, the beam direction of the wireless communication may be associated with a synchronization signal block index, a downlink transmission configuration indicator state, an uplink transmission configuration indicator state, a spatial relations of one or more communication beams, or a combination thereof.

In some examples of the method, network entities, and non-transitory computer-readable medium described herein, the set of communication parameters may be a set of zones and the method, apparatuses, and non-transitory computer-readable medium may include further operations, features, means, or instructions for outputting an indication that the UE may be operating within a first zone of the set of zones, where communicating with the UE may be based on the indication that the UE may be operating within the first zone.

Some examples of the method, network entities, and non-transitory computer-readable medium described herein may further include operations, features, means, or instructions for determining whether the UE may be in coverage of a wireless repeater or a RIS, or both, where identifying the subset of communication parameters may be based on determining whether the UE may be in coverage of the wireless repeater or the RIS, or both.

In some examples of the method, network entities, and non-transitory computer-readable medium described herein, the time and frequency resources associated with the full-duplex configuration include one or more subbands allocated for downlink communications and one or more subbands allocated for uplink communications.

A method for wireless communications by a network entity is described. The method may include identifying a set of multiple full-duplex configurations and a respective subset of communication parameters for which each of the set of multiple full-duplex configurations is applicable, each respective subset of communication parameters being from a set of communication parameters associated with a communication link between a UE and the network entity, outputting a control signal indicating the set of multiple full-duplex configurations and the respective subsets of communication parameters, each of the set of multiple full-duplex configurations including time and frequency resources for full-duplex communications, and communicating with the UE in accordance with a communication parameter and based on a first full-duplex configuration or another configuration.

A network entity for wireless communications is described. The network entity may include one or more memories storing processor executable code, and one or more processors coupled (e.g., operatively, communicatively, functionally, electronically, or electrically) with the one or more memories. The one or more processors may individually or collectively operable to execute the code (e.g., directly, indirectly, after pre-processing, without pre-processing) to cause the network entity to identify a set of multiple full-duplex configurations and a respective subset of communication parameters for which each of the set of multiple full-duplex configurations is applicable, each respective subset of communication parameters being from a set of communication parameters associated with a communication link between a UE and the network entity, output a control signal indicating the set of multiple full-duplex configurations and the respective subsets of communication parameters, each of the set of multiple full-duplex configurations including time and frequency resources for full-duplex communications, and communicate a wireless communication in accordance with a communication parameter and based on a first full-duplex configuration or another configuration.

Another network entity for wireless communications is described. The network entity may include means for identifying a set of multiple full-duplex configurations and a respective subset of communication parameters for which each of the set of multiple full-duplex configurations is applicable, each respective subset of communication parameters being from a set of communication parameters associated with a communication link between a UE and the network entity, means for outputting a control signal indicating the set of multiple full-duplex configurations and the respective subsets of communication parameters, each of the set of multiple full-duplex configurations including time and frequency resources for full-duplex communications, and means for communicating with the UE in accordance with a communication parameter and based on a first full-duplex configuration or another configuration.

A non-transitory computer-readable medium storing code for wireless communications is described. The code may include instructions executable by one or more processors (e.g., directly, indirectly, after pre-processing, without pre-processing) to identify a set of multiple full-duplex configurations and a respective subset of communication parameters for which each of the set of multiple full-duplex configurations is applicable, each respective subset of communication parameters being from a set of communication parameters associated with a communication link between a UE and the network entity, output a control signal indicating the set of multiple full-duplex configurations and the respective subsets of communication parameters, each of the set of multiple full-duplex configurations including time and frequency resources for full-duplex communications, and communicate a wireless communication in accordance with a communication parameter and based on a first full-duplex configuration or another configuration.

Some examples of the method, network entities, and non-transitory computer-readable medium described herein may further include operations, features, means, or instructions for outputting a signal including an indication to use the first full-duplex configuration based on the communication parameter associated with the wireless communication being included in the first subset of communication parameters, where communicating the wireless communication may be based on the indication to use the first full-duplex configuration.

In some examples of the method, network entities, and non-transitory computer-readable medium described herein, the signal includes an index of the first full-duplex configuration, an identifier associated with the first full-duplex configuration, or both.

In some examples of the method, network entities, and non-transitory computer-readable medium described herein, the signal may be one of RRC message, DCI, or a MAC-CE.

In some examples of the method, network entities, and non-transitory computer-readable medium described herein, the communicating may include operations, features, means, or instructions for communicating with the UE according to the other configuration based on respective time and frequency resources of the first full-duplex configuration at least partially overlapping with one or more common channels, one or more reference signals, or any combination thereof.

Some examples of the method, network entities, and non-transitory computer-readable medium described herein may further include operations, features, means, or instructions for outputting a signal including an indication to use the other configuration for the wireless communication based on the time and frequency resources of the first full-duplex configuration overlapping with the one or more common channels, the one or more reference signals, or any combination thereof.

In some examples of the method, network entities, and non-transitory computer-readable medium described herein, the signal including the indication may be a second control signal configuring the one or more common channels, a third control signal configuring the one or more reference signals, or any combination thereof.

In some examples of the method, network entities, and non-transitory computer-readable medium described herein, the one or more common channels include a RACH, a PDCCH, an PDSCH, a paging PDCCH, a paging PDSCH, or any combination thereof.

In some examples of the method, network entities, and non-transitory computer-readable medium described herein, the UE may be operating in a RRC inactive mode or a RRC idle mode, and the control signal includes a system information block.

In some examples of the method, network entities, and non-transitory computer-readable medium described herein, the UE may be operating in a RRC active mode, and the control signal includes a RRC message.

In some examples of the method, network entities, and non-transitory computer-readable medium described herein, the communication parameter includes one or more beams, one or more signal threshold associated with the one or more beams, a beam direction of the wireless communication, a geographic location of the UE, a downlink reception timing, an uplink transmission timing, a RTT of the wireless communication, one or more TAG identifiers, a type of communication link between the UE and the network entity, one or more outputs of a machine learning model, or any combination thereof.

In some examples of the method, network entities, and non-transitory computer-readable medium described herein, the beam direction of the wireless communication includes a synchronization signal block index, a downlink transmission configuration indicator state, an uplink transmission configuration indicator state, a spatial relations of one or more communication beams, or a combination thereof.

In some examples of the method, network entities, and non-transitory computer-readable medium described herein, the set of communication parameters may be a set of zones and the method, apparatuses, and non-transitory computer-readable medium may include further operations, features, means, or instructions for outputting an indication that the UE may be operating within a first zone of the set of zones, where communicating the wireless communication may be based on the indication.

Some examples of the method, network entities, and non-transitory computer-readable medium described herein may further include operations, features, means, or instructions for determining whether the UE may be in coverage of a wireless repeater or a RIS, or both, where identifying the set of multiple full-duplex configurations may be based on determining whether the UE may be in coverage of the wireless repeater or the RIS, or both.

In some examples of the method, network entities, and non-transitory computer-readable medium described herein, respective time and frequency resources associated with the full-duplex configuration include one or more subbands allocated for downlink communications and one or more subbands allocated for uplink communications.

### BRIEF DESCRIPTION OF THE DRAWINGS

FIG. 1 shows an example of a wireless communications system that supports beam-based full-duplex configurations in accordance with one or more aspects of the present disclosure.

FIG. 2 shows an example of a wireless communications system that supports beam-based full-duplex configurations in accordance with one or more aspects of the present disclosure.

FIG. 3 shows an example of a wireless communications system that supports beam-based full-duplex configurations in accordance with one or more aspects of the present disclosure.

FIG. 4 shows an example of a wireless communications system that supports beam-based full-duplex configurations in accordance with one or more aspects of the present disclosure.

FIG. 5 shows an example of a process flow that supports beam-based full-duplex configurations in accordance with one or more aspects of the present disclosure.

FIG. 6 shows an example of a process flow that supports beam-based full-duplex configurations in accordance with one or more aspects of the present disclosure.

FIGS. 7 and 8 show block diagrams of devices that support beam-based full-duplex configurations in accordance with one or more aspects of the present disclosure.

FIG. 9 shows a block diagram of a communications manager that supports beam-based full-duplex configurations in accordance with one or more aspects of the present disclosure.

FIG. 10 shows a diagram of a system including a device that supports beam-based full-duplex configurations in accordance with one or more aspects of the present disclosure.

FIGS. 11 and 12 show block diagrams of devices that support beam-based full-duplex configurations in accordance with one or more aspects of the present disclosure.

FIG. 13 shows a block diagram of a communications manager that supports beam-based full-duplex configurations in accordance with one or more aspects of the present disclosure.

FIG. 14 shows a diagram of a system including a device that supports beam-based full-duplex configurations in accordance with one or more aspects of the present disclosure.

FIGS. 15 through 22 show flowcharts illustrating methods that support beam-based full-duplex configurations in accordance with one or more aspects of the present disclosure.

### DETAILED DESCRIPTION

In some wireless communications systems, a network entity may perform full-duplex communications with multiple user equipments (UEs). For example, the network entity may transmit one or more downlink messages to a first UE, while simultaneously receiving one or more uplink messages from a second UE. To facilitate such communications, the network entity may utilize time and frequency resources configured for full-duplex communications (e.g., sub-band full-duplex (SBFD) time and frequency resources), which may include at least a first frequency subband allocated for downlink communications and a second frequency subband allocated for uplink communications. The network entity may indicate such time and frequency resources to both the first and second UE, such that each UE may be aware of the full-duplex communications occurring at the network entity and adjust various communication parameters accordingly.

In some cases, however, resources having such full-duplex configurations may not be beneficial for communications between the network entity and one of the UEs, leading to communication mismatches and increased latency for the network entity, one or more of the UEs, or any combination thereof. For example, the network entity may communicate with the first UE using SBFD time and frequency resources via a direct link (e.g., no relays or interruptions between the UE and the network entity), while also communicating with the second UE using such SBFD time and frequency resources via a repeater (e.g., a wireless relay, a wireless repeater, a reconfigurable intelligent surface (RIS), or the like). In such cases, the repeater may not be able to support SBFD forwarding (e.g., communication via SBFD resources), which may restrict the communication between the second UE and the network entity. Additionally, or alternatively, the network entity may identify that a communication beam between the first UE and the network entity has a relatively poor communication performance while using the SBFD time and frequency resources, leading to increased latency in communications between the first UE and the network entity.

The techniques, methods, and devices described herein may support beam-based SBFD configurations (e.g., beam-specific SBFD configurations), such that a UE may determine whether to use an SBFD configuration (e.g., SFBD time and frequency resources, an SFBD slot) or another configuration (e.g., uplink slot or downlink slot, half-duplex slot) for wireless communications with the network entity. In some examples, the network entity may transmit a control signal that indicates an SBFD configuration and a subset of communication parameters (e.g., beams, directions, geographical zones, timing advance groups (TAGs), communication coverages) for which the SBFD configuration is applicable for wireless communications, where the subset of communication parameters are from a set of communications parameters associated with (e.g., based on) a communication link between the UE and the network entity.

The UE may identify whether to utilize the SBFD configuration or the other configuration for communication with the network entity based on a communication parameter (e.g., beam direction, geographical zone of the UE, a TAG of the UE) associated with the wireless communication between the UE and the network entity. In some other examples, the network entity may transmit a control signal indicating multiple SBFD configurations (e.g., multiple time and frequency resources for SBFD slots), where each SBFD configuration is associated with a respective subset of communication parameters. Accordingly, the UE may identify, based on a communication parameter of a wireless communication, which SBFD configuration to use for such communications with the network entity. In this way, the UE may determine whether to use SBFD resources or other resources for communication with the network entity based on the set of communication parameters, thereby improving coordination between the UE and the network entity. Such improved coordination may lead to a reduction in latency and an improvement in communication efficiency and reliability, among other advantages.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to beam-based full-duplex configurations.

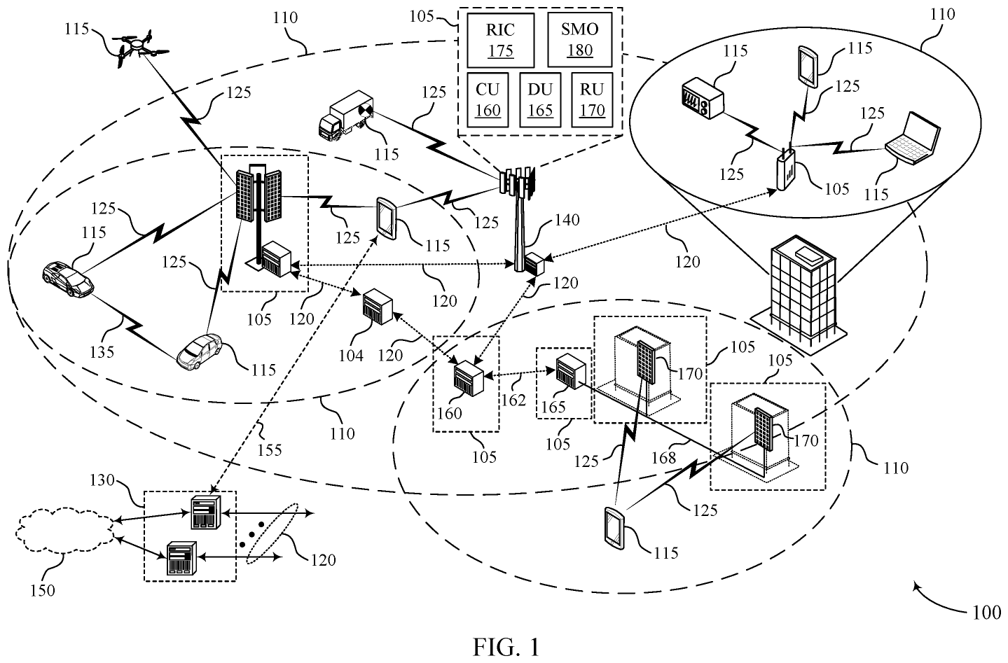

FIG. 1 shows an example of a wireless communications system 100 that supports beam-based full-duplex configurations in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support beam-based full-duplex configurations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, an MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A quasi co-location (QCL) relationship between one or more transmissions or signals may refer to a relationship between the antenna ports (and the corresponding signaling beams) of the respective transmissions. For example, one or more antenna ports may be implemented by a network entity 105 for transmitting at least one or more reference signals (such as a downlink reference signal, a synchronization signal block (SSB), or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being quasi co-located (QCLed). QCLed signals may enable the UE 115 to derive the properties of a first signal (e.g., delay spread, Doppler spread, frequency shift, average power) transmitted via a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as CSI-RS) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relationship between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relationship between two or more directional beams used to communicate signals. Here, the spatial parameters may indicate that a first beam used to transmit a first signal may be similar (or the same) as another beam used to transmit a second, different, signal, or, that the same receive beam may be used to receive both the first and the second signal. Thus, the beam information for various beams may be derived through receiving signals from a transmitting device, where, in some cases, the QCL information or spatial information may help a receiving device efficient identify communications beams (e.g., without having to sweep through a large quantity of beams to identify a beam (e.g., the beam having a highest signal quality)). In addition, QCL relationships may exist for both uplink and downlink transmissions and, in some cases, a QCL relationship may also be referred to as spatial relationship information.

In some examples, TCI states may include one or more parameters associated with a QCL relationship between transmitted signals. For example, each TCI state includes parameters for configuring a QCL relationship between one or two downlink reference signals and the DMRS ports of PDSCH, the DMRS port of PDCCH or the CSI-RS port(s) of a CSI-RS resource. The QCL relationship is configured by a first higher layer parameter for the first downlink reference signal, and by a second higher layer parameter for the second downlink reference signal (if configured). That is, a network entity 105 may configure a QCL relationship that provides a mapping between a reference signal and antenna ports of another signal, and the TCI state may be indicated to the UE 115 by the network entity 105. In some cases, a set of TCI states (e.g., a list of TCI states) may be indicated to a UE 115 via RRC signaling, where some quantity of TCI states may be configured via RRC and one or more TCI states may be indicated (e.g., activated) via a medium access control (MAC)-control element (MAC-CE), and further indicated via DCI (e.g., within a CORESET). The QCL relationship associated with the TCI state (and further established through higher-layer parameters) may provide the UE 115 with the QCL relationship for respective antenna ports and reference signals transmitted by the network entity 105.

Some wireless communication systems (e.g., 5G or NR systems) may support various enhancements to increase throughput between nodes of the wireless communication system. For example, some wireless communication systems may support enhancements to duplex evolution for time division duplexing (TDD) in an unpaired spectrum. Enhancements to duplex evolution may include duplex enhancements at the network entities 105, enhancements to half-duplex operations at the UEs 115, and elimination restriction on frequency ranges (e.g., no restrictions) for communications between the network entities 105 and the UEs 115.

In some cases, the network entity 105 and the UE 115 may implement subband non-overlapping full duplex (e.g., SBFD) communications in order to reduce intra-subband and inter-subband cross link interference (CLI), where such subband non-overlapping full-duplex communications may have a reduced impact on various legacy (e.g., half-duplex) operations when both legacy and full-duplex communications coexist in a co-channel and adjacent channels. To facilitate the subband non-overlapping full-duplex communications, the network entity 105 and the UE 115 may support radio frequency (RF) enhancements in adjacent-channel co-existence with the subband full-duplex and half-duplex communications, where such RF enhancements may reduce self-interference, reduce inter-subband CLI and inter-operator CLI at the network entities 105, reduce inter-subband CLI and inter-operator CLI at the UEs 115, or a combination thereof. Such RF enhancements may include enhancements to antennas and algorithm designs at the respective devices, which may include antenna isolation, transmission interference measurement (IM) suppression in the receiving part, filtering and digital interference suppression, or a combination thereof.

Such subband non-overlapping full-duplex enhancements may enable the network entity 105 to perform full-duplex communications with multiple UEs 115. For example, the network entity 105 may transmit one or more downlink messages to a first UE 115, while simultaneously receiving one or more uplink messages from a second UE 115. The network entity 105 may utilize SBFD time and frequency resources (e.g., an SBFD configuration), which includes at least a first frequency subband allocated for downlink communications and a second frequency subband allocated for uplink communications. The network entity 105 may indicate such time and frequency resources to both the first and second UE 115, such that each UE 115 may be aware of the full-duplex communications occurring at the network entity 105 and adjust various communication parameters accordingly.

In some cases, however, resources having such SBFD configurations may not be beneficial for communications between the network entity 105 and one of the UEs 115, leading to communication mismatches and increased latency for the network entity 105, for one or more UEs 115, or any combination thereof. For example, the network entity 105 may communicate with the first UE 115 using SBFD time and frequency resources via a direct link (e.g., no relays or interruptions between the UE 115 and the network entity 105), while also communicating with the second UE 115 using such SBFD time and frequency resources via a repeater. In such cases, the repeater may not be able to support SBFD forwarding (e.g., communication via SBFD resources), which may restrict the communication between the second UE 115 and the network entity 105. Additionally, or alternatively, the network entity 105 may identify that a communication beam between the first UE 115 and the network entity 105 has a relatively poor communication performance while using the SBFD time and frequency resources, leading to increased latency in communications between the first UE 115 and the network entity 105.

The techniques, methods, and devices described herein may support beam-based SBFD configurations (e.g., beam-specific SBFD configurations), such that a UE 115 may determine whether to use an SBFD configuration (e.g., SFBD time and frequency resources, an SFBD slot) or another configuration (e.g., uplink slot or downlink slot, half-duplex slot) for communications with the network entity 105. In some examples, the network entity 105 may transmit a control signal that indicates an SBFD configuration and indicates a subset of communication parameters (e.g., beams, directions, geographical zones, timing advance groups (TAGs), communication coverages) for which the SBFD configuration is applicable for wireless communications, where the subset of communication parameters are from a set of communications parameters associated with (e.g., based on) a communication link between the UE 115 and the network entity 105.

The UE 115 may identify whether to utilize the SBFD configuration or the other configuration for communication with the network entity 105 based on a communication parameter associated with the wireless communication between the UE 115 and the network entity 105. In some other examples, the network entity 105 may transmit a control signal indicating multiple SBFD configurations (e.g., multiple time and frequency resources for SBFD slots), where each SBFD configuration is associated with a respective subset of communication parameters. Accordingly, the UE 115 may identify, based on a communication parameter of a wireless communication, which SBFD configuration to use for such communications with the network entity 105.

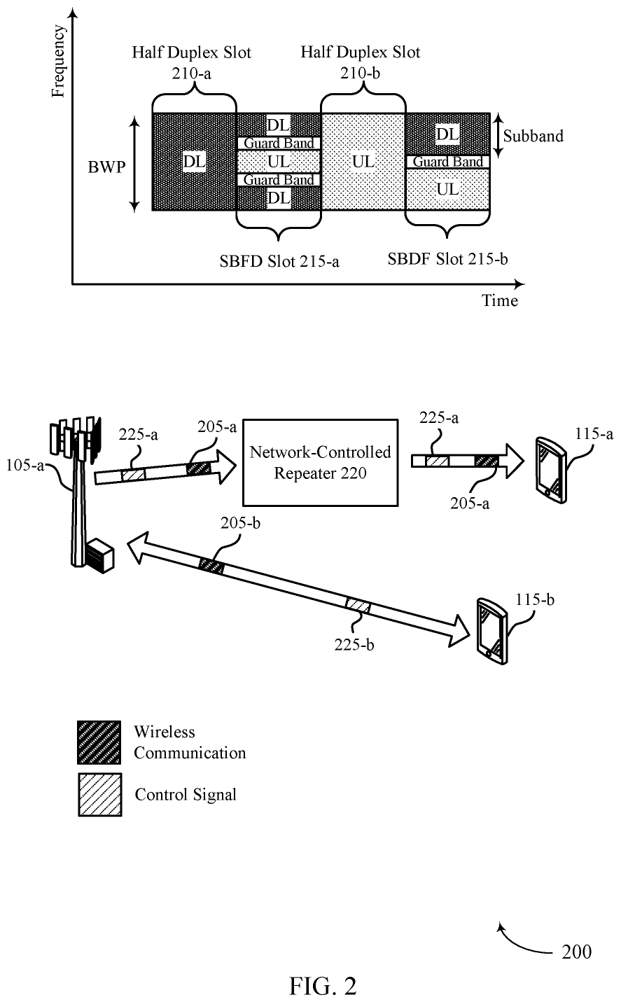

FIG. 2 shows an example of a wireless communications system 200 that supports beam-based full-duplex configurations in accordance with one or more aspects of the present disclosure. The wireless communications system 200 may implement, or be implemented by, aspects of wireless communications system 100 with reference to FIG. 1. For example, the wireless communications system 200 may include a network entity 105-a, which may be an example of the network entity 105. Additionally, the wireless communications system 200 may include a UE 115-a and a UE 115-b, which may be examples of UEs 115 described herein with reference to FIG. 1. The techniques described in the context of the wireless communications system 200 may enable the UEs 115 and network entity 105-a to transmit and receive data via SBFD configurations (resources) that are associated with a subset of communication parameters. For example, some SBFD configuration may be beam specific and may therefore be used for communication between a UE 115 and the network entity 105-a in some direction associated with a beam.

The network entity 105-a may communicate (e.g., transmit, receive, or both) wireless communications 205 (e.g., using one or more messages including data and/or control information) with the UE 115-a and the UE 115-b. For example, to perform downlink communications, the network entity 105-a may transmit one or more wireless communications 205 via a half-duplex slot 210-a, where the half-duplex slot 210-a may include a BWP allocated for the downlink communication. Similarly, to perform uplink communications, the network entity 105-a may receive one or more wireless communications via a half-duplex slot 210-b, where the half-duplex slot 210-b may include a BWP allocated for the uplink communication. In such cases, the network entity 105-a may indicate, via control signaling, the time and frequency resources of the half-duplex slot 210-a and the half-duplex slot 210-b to the UEs 115.

In some cases, the network entity 105-a may perform simultaneous transmission and reception between the UEs 115 (e.g., perform full-duplex MU-MIMO communications, which may be referred to as downlink/uplink MU-MIMO). To facilitate such communications, the network entity 105-a may utilize SBFD resources that define a single slot where at least a first frequency subband of the slot is allocated to uplink communications and a second frequency subband of the slot is allocated to downlink communications. The SBFD resources may be within a TDD carrier, be within a single configured downlink and uplink BWP pair with aligned center frequencies and include up to one uplink subband for SBFD operation in an SBFD symbol (excluding legacy uplink symbols) within a TDD carrier. To facilitate communications via the SBFD resources, the network entity 105-a may indicate both the time and frequency locations of subbands for SBFD operation to SBFD aware UEs 115. Accordingly, non-SBFD aware UEs 115 (e.g., such as reduced capability UEs) may follow existing communication protocols. As used herein, a SBFD-aware UE 115 may be a UE 115 that receives an indication of time and frequency domain locations of some full-duplex resources (e.g., SBFD subbands).

By utilizing such SBFD resources to perform full-duplex MU-MIMO communication, the network entity 105-a may increase the uplink duty cycle, which may lead to latency reduction. For example, the network entity 105-a may transmit an uplink signal in the uplink subband of a downlink or flexible slot, or receive downlink signal in downlink subband(s) in an uplinks slot, which may provide latency savings. Additionally, utilizing such SBFD resources may provide uplink coverage improvement, enhance system capacity, resource utilization, and spectrum efficiency, while also enabling flexible and dynamic uplink and downlink resource adaption according to the amount of uplink and downlink traffic at the network entity 105-a.

As an illustrative example, the network entity 105-a may perform the full-duplex operations via a SBFD slot 215-a, where the SBFD slot 215-a may include an upper subband allocated to downlink communications, a middle subband allocated to uplink communications, and a lower subband allocated to downlink communications. Additionally, the SBFD slot 215-a may include one or more guard bands to separate the different subbands, thereby reducing inter-subband interference. As another illustrative example, the network entity 105-a may perform the full-duplex operations via a SBFD slot 215-b, where the SBFD slot 215-b includes an upper subband allocated for downlink communications, a lower subband allocated for uplink communications, and a guard band in between the upper and lower subband. Accordingly, the network entity 105-a may transmit a wireless communication 205-a to the UE 115-a via the downlink subband of the SBFD slot 215-a or SBFD slot 215-b, while simultaneously receiving a wireless communication 205-b from the UE 115-b via the uplink subband of the SBFD slot 215-a or SBFD slot 215-b.

The network entity 105-a may communicate with the UEs 115 via one or more communication links (e.g., communication paths). For example, the network entity 105-a may communicate with the UE 115-b via a direct link (e.g., a link that does not include one or more relay nodes between the UE 115-b and the network entity 105-a). The network entity 105-a may communicate with the UE 115-a via a network-controlled repeater 220, a RIS (not shown), or both. For example, the network entity 105-a may transmit the wireless communication 205-a to the network-controlled repeater 220, where the network-controlled repeater may forward the wireless communication 205-a to the UE 115-a.

The network-controlled repeater 220 may include a network-controlled mobile termination node that is responsible for receiving, from the network entity 105-a via a control link, semi-static TDD information (semi-static resources). The network-controlled repeater may use the semi-static TDD information to determine a forwarding direction (e.g., whether to transmit uplink or downlink) in each symbol. To facilitate such forwarding, the network-controlled repeater 220 may include a network-controlled forwarding node that forwards a wideband analog signal over an operating bandwidth that encompasses the component carrier used by the network-controlled mobile termination node. In such cases, the network-controlled forwarding node may not function (e.g., be turned off) when semi-static flexible resources are indicated to the network-controlled mobile termination node. That is, the network-controlled repeater 220 may not support dynamic operations, such as dynamic indication of resources.

As an illustrative example, the network-controlled mobile termination node may receive an indication of semi-static resources for a downlink communication to the UE 115-a. Accordingly, the network entity 105-a may transmit, via a backhaul link, the wireless communication 205-a. The network-controlled forward node of the network-controlled repeater 220 may forward the wireless communication 205-a via an access link to the UE 115-a. Similarly, the network-controlled mobile termination node may receive an indication of semi-static resources for an uplink communication from the UE 115-a, where the UE 115-a may transmit an uplink communication to the network-controlled forwarding node via an access link. As such, the network-controlled forwarding node may forward the uplink communication to the network entity 105-a via a backhaul link. In this way, the network entity 105-a and the UE 115-a may communicate via the network-controlled repeater 220.

In the case of MU-MIMO full-duplex communications, however, the network-controlled repeater (or RIS) may not support SBFD forwarding (e.g., communication via SBFD resources), which may restrict the communication between the UE 115-a and the network entity 105-a. That is, the network-controlled repeater 220 may not support communications using the resource structure of the SBFD slot 215-a and the SBFD slot 215-b. As such, during the full-duplex communications, the network entity 105-a may be unable to provide the wireless communication 205-a to the UE 115-a via the network-controlled repeater 220 using the SBFD slots 215, leading to increased latency in communications between the UE 115-a and the network entity.

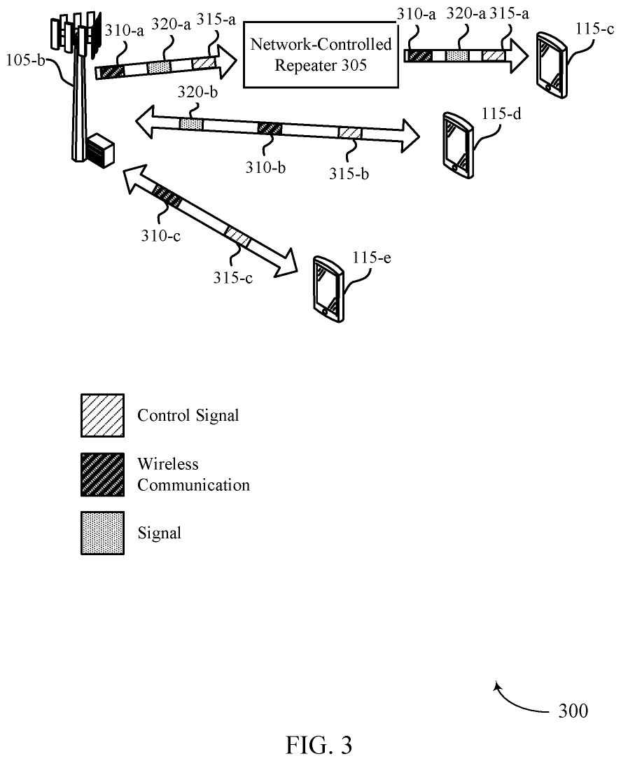

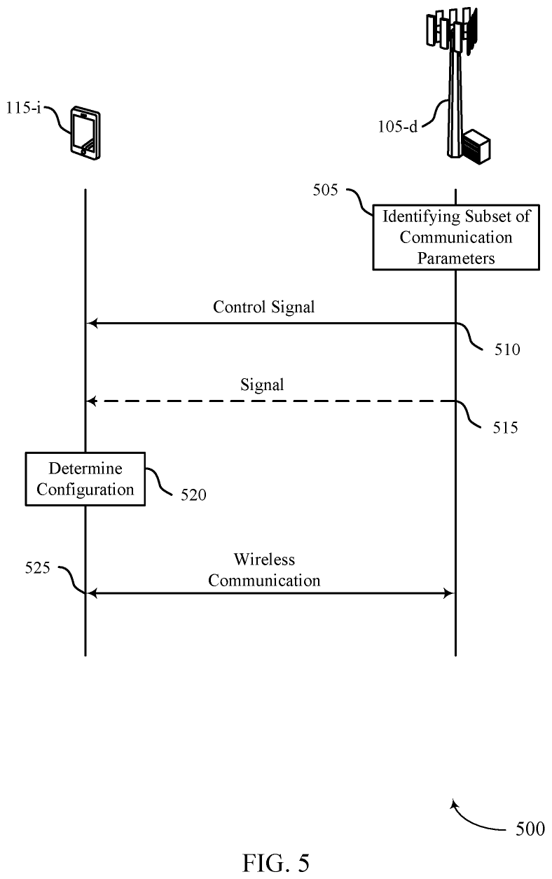

In accordance with the techniques described herein, the network entity 105-a may provide the UEs 115 with one or more SBFD configurations that are applicable for a subset of communication parameters. In some examples, the network entity 105-a may transmit a control signal 225 that indicates an SBFD configuration (e.g., time and frequency resources for full-duplex communications, resources for the SBFD slot 215) and indicates a subset of communication parameters for which the SBFD configuration is applicable for wireless communications 205. In such examples, the UEs 115 may identify whether to utilize the SBFD configuration or the other configuration for communication with the network entity 105-a based on a communication parameter (e.g., beam direction, geographical zone of the UE, a TAG of the UE) associated with the wireless communication between the UEs 115 and the network entity 105-a. Such techniques may be further described herein with reference to FIGS. 3 and 5.

As an illustrative example, the UE 115-b may receive a control signal 225-b indicating the SBFD configuration and associated subset of communication parameters. The UE 115-b may identify that a communication parameter (e.g., beam, beam direction, geographical zone of the UE, or the like) of the wireless communication 205-b is included in the subset of the communication parameters associated with the SBFD configuration. As such, the UE 115-b may transmit the wireless communication 205-b to the network entity 105-a using the resources of the SBFD configuration. The UE 115-a may also receive a control signal 225-b indicating the SBFD configuration and the subset of communication parameters. As such, the UE 115-a may identify that a communication parameter associated with the wireless communication 205-a is excluded from the subset of communication parameters associated with the SBFD configuration. As such, the UE 115-a may receive the wireless communication 205-a from the network entity via the resources of the other configuration (e.g., the half-duplex slot 210-a).

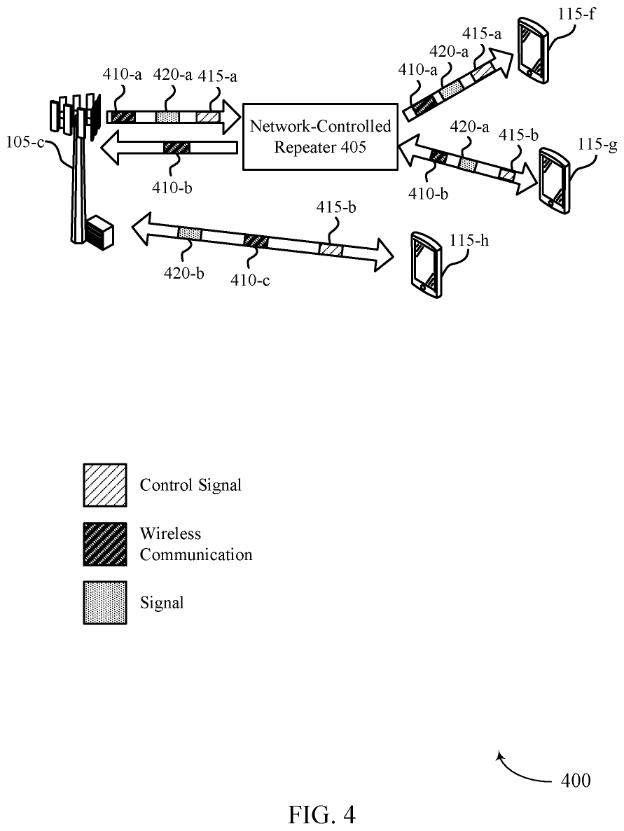

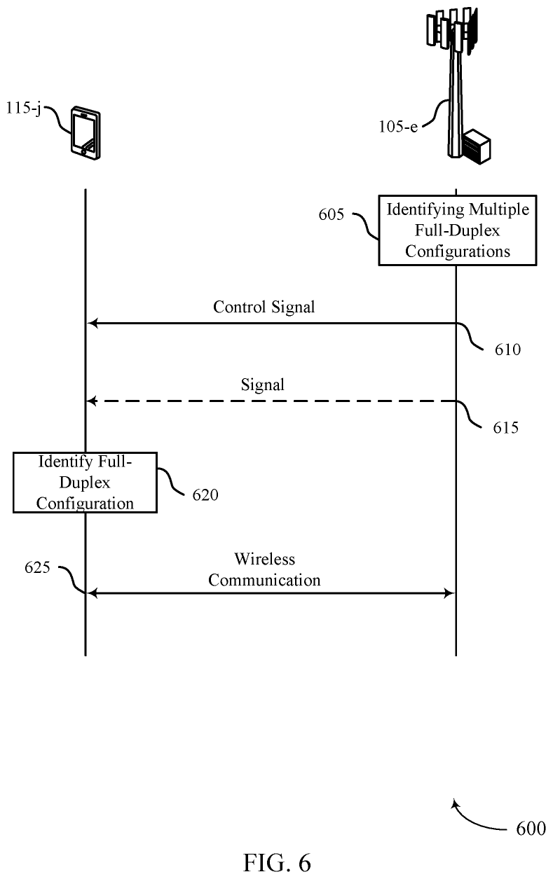

In some other examples, the network entity 105-a may transmit a control signal 225 indicating multiple SBFD configurations (e.g., multiple time and frequency resources for SBFD slots), where each SBFD configuration is associated with a respective subset of communication parameters. Accordingly, the UEs 115 may identify, based on a communication parameter of a wireless communication, which SBFD configuration to use for such communications with the network entity 105-a. Such techniques may be further described herein with reference to FIGS. 4 and 6.

As an illustrative example, the network entity 105-a may transmit, via the control signal 225-b and the control signal 225-a, respectively, three SBFD configurations, each associated with a respective subset of communication parameters. Accordingly, the UE 115-b may determine to use the resources indicated in the third SBFD configuration for the wireless communication 205-b based on a communication parameter of the wireless communication 205-b being included in the subset of the communication parameters associated with the third SBFD configuration. Alternatively, the UE 115-a may identify to use the resources indicated in the second SBFD configuration, based on a communication parameter of the wireless communication 205-a being included in the subset of communication parameters associated with the second SBFD configuration.

In such examples, if the UEs 115 are operating in an active mode (e.g., an RRC_CONNECTED mode), the control signal 225 may be an RRC signal. For example, the UEs 115 (e.g., SBFD-aware UEs 115) may perform a random access procedure during SBFD symbols (of the SBFD slots 215), which may reduce the random access latency, reduce the physical random access channel (PRACH) collision probability, and improve the coverage of PRACH and RRC signaling (e.g., RRC message three). PRACH and RRC signaling (e.g., RRC message three) in an uplink subband of an SBFD symbol may cause UE-to-UE CL. However, the UEs 115 may support random access in SBFD symbols at least for PRACH and RRC signaling via symbols configured as downlink (configured in TDD-UL-DL-ConfigCommon information element). Accordingly, the UEs 115 may receive the SBFD configurations and associated subset of communication parameters via RRC signaling when operating in the active mode.

In some other examples, if the UEs 115 are operating in an idle or inactive mode (e.g., RRC_IDLE or RRC_INACTIVE), the control signal 225 may be a system information block signal (SIB) (e.g., SIB1 message). For example, instead of indicating the beam-specific SBFD configurations via RRC signaling while the UEs 115 operate in the active mode, if random access is allowed in SBFD symbols for the UEs 115 (e.g., SBFD-aware UEs 115), the UEs 115 may also support indication of the SBFD configurations via system information during idle or inactive modes. Accordingly, the UEs 115 may receive the SBFD configurations and associated subset of communication parameters via a SIB when operating in the idle or inactive modes.

A communication parameter may be an example of one or more beams (of the serving cell, neighboring cell, or non-serving cell), one or more signal thresholds associated with the one or more beams (e.g., signal quality thresholds), a beam direction of the wireless communication 205, a geographic location of the UE 115 (e.g., relative to the network entity 105-a or global positioning system (GPS) coordinates), a downlink reception timing, an uplink transmission timing, a round-trip time (RTT) of the wireless communication 205, one or more TAG identifiers (IDs), or any combination thereof.

In some examples, the communication parameter may be a type of communication link between the network entity 105-a and the UEs 115 (e.g., whether the UEs are under the coverage of an RIS or network-controlled repeater 220). For example, to determine whether the UEs are under the coverage of an RIS or the network-controlled repeater 220, the UEs 115 may identify the signals forwarded by the network-controlled repeater 220 (or RIS) via a watermark on the signal, via a frequency shift of the signal, or via a phase or polarization shift of the signal.

In some examples, the communication parameter may be an output of an artificial intelligence or machine learning model, where the input to the model may be a beam, beam direction, geographical location, a downlink timing, uplink timing, RTT, or TAG ID that has been associated with the UE for a threshold amount of time (e.g., for the last T seconds). In some examples, the communication parameter may be a zone defined by the network entity 105-a, where the network entity 105-a may provide an explicit indication of the zone in which the UEs 115 are operating.

FIG. 3 shows an example of a wireless communications system 300 that supports beam-based full-duplex configurations in accordance with one or more aspects of the present disclosure. The wireless communications system 300 may implement, or be implemented by, aspects of the wireless communications system 100 and the wireless communications system 200 with reference to FIGS. 1 and 2. For example, the wireless communications system 300 may include a network entity 105-b and a network-controlled repeater 305, which may be examples of the network entity 105-a and the network-controlled repeater 220, respectively, as described herein. Further, the wireless communications system 300 may include a UE 115-c, a UE 115-d, and a UE 115-e, which may be examples of the UEs 115 described herein with reference to FIGS. 1 and 2. The techniques described in the context of the wireless communications system 300 may enable the UEs 115 to determine whether to use a SBFD configuration or another configuration for a wireless communication 310 (e.g., using one or more messages including data and/or control information) based on a communication parameter of the wireless communication 310 and a subset of communication parameters associated with the SBFD configuration.

For example, some communication links of the network entity 105-b may be associated with the network-controlled repeater 305, where the network-controlled repeater 305 may forward signals associated with one or more beams or synchronization signal blocks of the network entity 105-b. In such examples, the network-controlled repeater 305 may be unable to support bi-directional or SBFD forwarding (e.g., the network-controlled repeater 305 is a TDD repeater). Accordingly, the network entity 105-b may be unable to support SBFD operation in such communication links (e.g., beam directions). However, for other communication links, such as respective communication links with the UE 115-d and the UE 115-e directly under the coverage of the network entity 105-b, the network entity 105-b may support SBFD operation.

In accordance with the techniques described herein, the network entity 105-b may indicate, via control signals 315, an SBFD configuration and a subset of communication parameters for which the SBFD configuration is applicable for the wireless communications 310. In some examples, the network entity 105-b may identify the subset of communication parameters based on the communication links between each of the UEs 115 and the network entity 105-b. That is, the network entity 105-b may determine a type of communication link between each of the UEs 115 and identify the subset of communication parameters for which the SBFD configuration is applicable based on the type of communication link. As an illustrative example, the network entity 105-b may determine that the UE 115-c is operating under the coverage of the network-controlled repeater 305 and determine that the UE 115-d and the UE 115-e are operating via a direct link with the network entity 105-b. Accordingly, the network entity 105-b may identify that the SBFD configuration is applicable for the subset of communication parameters corresponding to the communication links of the UE 115-d and the UE 115-e.

Based on identifying the subset of communication parameters, the network entity 105-b may transmit an indication of the SBFD configuration and the subset of communication parameters to the UEs 115 via respective control signals 315. For example, the network entity 105-b may transmit a control signal 315-a, to the UE 115-c via the network-controlled repeater 305, transmit a control signal 315-b to the UE 115-d, and transmit a control signal 315-c to the UE 115-e. In such examples, the SBFD configuration may be a cell common semi-static time and frequency SBFD configuration. Accordingly, the UEs 115 under the coverage of different directions (e.g., supporting or not supporting SBFD operation) may receive the cell common semi-static time and frequency configuration. That is, even though the UE 115-c is operating under a communication link that does not support SBFD operation, the UE 115-c may receive, via the control signal 315-a, an indication of the SBFD configuration.

In response to receiving the control signals 315, the UEs 115 may determine whether to use the SBFD configuration or another configuration (e.g., half-duplex configuration) for the wireless communications 310 based on the subset of communication parameters and a communication parameter associated with the wireless communications 310. In some examples, for wireless communications 310 (e.g., transmissions or receptions) associated with communication parameters that are excluded from the subset of communication parameters for the SBFD configuration (e.g., for wireless communication 310 that do not support SBFD operations), by an implicit rule, the UEs 115 may drop or ignore the SBFD configuration and use the other configuration (e.g., follow legacy UE behavior) for the wireless communications 310.

For example, the UE 115-c may determine that the communication parameter associated with the wireless communication 310-a (e.g., a downlink transmission) is excluded from the subset of communication parameters in which the SBFD configuration is applicable. Accordingly, by the implicit rule, the UE 115-c may drop the SBFD configuration and use the other configuration for the wireless communication 310-a. Alternatively, the UE 115-d may determine that the communication parameter associated with the wireless communication 310-b is included in the subset of communication parameters in which the SBFD configuration is applicable. As such, the UE 115-d may use the SBFD configuration for the wireless communication 310-b. Similarly, the UE 115-e may determine that the communication parameter associated with the wireless communication 310-c is included in the subset of communication parameters, and use the SBFD configuration for the wireless communication 310-c.

In some other examples, for wireless communications 310 (e.g., transmissions or receptions) with a communication parameter excluded from the subset of communications parameters associated with the SBFD configuration (e.g., for wireless communications 310 in directions that do not support SBFD operations), the UEs 115 may receive an explicit indication to drop or ignore the SBFD configuration and use the other configuration for the wireless communications 310 (e.g., follow legacy UE behaviors).

For example, the communication parameter associated with the wireless communication 310-a may be excluded from the subset of communication parameters for which the SBFD configuration is applicable. Accordingly, the network entity 105-b may transmit a signal 320-a indicating for the UE 115-c to drop the SBFD configuration and use the other configuration for the wireless communication 310-a. In such examples, the signal 320-a (e.g., explicit indication) may be a scheduling DCI associated with the wireless communication 310-a (e.g., a DCI that is associated with the scheduled transmission or reception corresponding to the subset of directions excluded from SBFD operation). In some other examples, the signal 320-a may be an RRC signal indicating the persistent or semi-persistent wireless communication 310-a (e.g., a RRC signal indicating the persistent or semi-persistent transmission or reception occasions that corresponds to the subset of directions excluded from SBFD operation). Additionally, or alternatively, the signal 320-a may be a MAC-control element (MAC-CE) associated with the wireless communication 310-a (e.g., MAC-CE associated with the transmission or reception occasions that are within a time window corresponding to the subset of directions excluded from SBFD operations).

In some examples, whether one or more channels, such as RACH, PRACH, remaining minimum system information (RMSI) physical downlink control channel (PDCCH), RMSI physical downlink shared channel (PDSCH), paging PDCCH, or paging PDSCH, or one or more reference signals, such as SSBs, are supported within SBFD symbols may be based on the communication parameters associated with the wireless communications 310 (e.g., be based on the beams used by the UEs 115). That is, whether SBFD operation is supported in symbols overlapping with such reference signals or channels may be based on the communication parameter associated with the wireless communications 310.

For example, the UEs 115 may determine whether to use the SBFD configuration or the other configuration based on whether time and frequency resources of the one or more channels, of the one or more reference signals, or both, at least partially overlap with the time and frequency resources indicated via the SBFD configuration. In some examples, for the one or more channels, one or more reference signals, or both, that are associated with the subset of communication parameters that do not support SBFD operation, by an implicit rule, the UEs 115 may drop or ignore the SBFD configuration and use the other configuration for the wireless communications 310 (e.g., follow legacy UE behaviors).

As an illustrative example, the UE 115-d may determine that the time and frequency resources of the SBFD configuration partially overlap with time and frequency resources of the one or more channels, the one or more reference signals, or both. Accordingly, the UE 115-d may drop the SFBD configuration and use the other configuration for the wireless communication 310-b. Alternatively, if the time and frequency resources of the SBFD configuration do not overlap with those of the one or more channels, the one or more reference signals, or both, and the communication parameter of the wireless communication 310-b is included in the subset of communication parameters, then the UE 115-d may utilize the SBFD configuration for the wireless communication 310-b.

In some other examples, for the one or more channels, one or more reference signals, or both, that are associated with the subset of communication parameters that do not support SBFD operation, the UEs 115 may receive an explicit indication to drop or ignore the SBFD configuration and use the other configuration for the wireless communications 310 (e.g., follow legacy UE behaviors). The indication may be configuration signaling of the common channels, configuration signaling of the one or more reference signals, or both. For example, the time and frequency resources of the SBFD configuration may at least partially overlap with those of one or more channels, one or more reference signals, or both. Accordingly, the network entity 105-b may transmit a signal 320-b to the UE 115-d indicating for the UE 115-d to drop the SBFD configuration and use the other configuration for the wireless communication 310-b. Based on the signal 320-b, the UE 115-d may drop the SBFD configuration.

As described herein, the communication parameter may be one or more beams and associated beam directions. Accordingly, the network entity 105-b may perform the SBFD operation based on beam-specific SBFD configurations. For example, the network entity 105-b may identify a subset of beams and beam directions for which an SBFD configuration is applicable for wireless communications 310. In such examples, the network entity 105-b may identify that a first beam and beam direction associated with communications with the UE 115-c may be unable to support SBFD operations based on the UE 115-c being in the coverage area of the network-controlled repeater 305, while also identifying that a second beam and beam direction associated with communications with the UE 115-d and a third beam and beam direction associated with communication with the UE 115-e may support SBFD operations.

As such, the network entity 105-b may indicate, to the UEs 115, that the SBFD configuration is not applicable in a subset of beam directions or is applicable in a subset of beam directions. That is, the network entity 105-b may transmit, via the control signals 315, an indication of the SBFD configuration and an indication of the subset of beam directions for which the SBFD configuration is applicable. To indicate the subset of beams and beam directions, the network entity 105-b may include, in the control signal, SSB indices of the beams for which the SBFD configuration is applicable, downlink TCI states of the beams for which the SBFD configuration is applicable, uplink TCI states of the beams for which the SBFD configuration is applicable, spatial relationships of the beams for which the SBFD configuration is applicable, or any combination thereof.

Based on the subset of beams and beam directions and a beam direction of the respective wireless communications 310, the UEs 115 may determine whether to use the SBFD configuration or the other configuration. For example, the UE 115-c may determine that the beam and beam direction associated with receiving the wireless communication 310-a may be excluded from the subset of beams and beam directions for which the SBFD configuration is applicable. Accordingly, the UE 115-c may receive the wireless communication 310-a, via the beam, according to the resources of the other configuration. The UE 115-d and the UE 115-e may determine that the respective beams and beam directions are included in the subset of beams and beam directions for which the SBFD configuration is applicable. As such, the UE 115-d and the UE 115-e may communicate the respective wireless communications 310 using the respective beams and the SBFD configurations.

In some examples, the communication parameter may be an example of signal thresholds of one or more beams. For example, the network entity 105-b may measure the signal quality of the beams used to communicate with each of the UEs 115. Based on the signal qualities, the network entity 105-b may identify a signal quality threshold for which the SBFD configuration is applicable. Accordingly, the network entity 105-b may indicate the signal quality threshold and the SBFD configuration to the UEs 115, where the UEs 115 may measure the respective signal qualities. Accordingly, the UEs 115 may compare the measured signal qualities to the signal quality threshold to determine whether to use the SBFD configuration or the other configuration.

In some other examples, the communication parameter may be an example of a geographical location. For example, the network entity 105-b may identify the coverage area of the network-controlled repeater 305 and determine that UEs 115 under such a coverage area may not support use of the SBFD configuration. Accordingly, the network entity 105-b may determine a subset of geographical locations for which the SBFD configuration is applicable based on identifying the coverage area of the network-controlled repeater 305. The network entity 105-b may indicate the subset of geographical locations to the UEs 115, where the UEs 115 may determine whether to use the SBFD configuration or the other configuration (e.g., a legacy configuration) based on whether a geographical location of the UE is included in the subset of geographical locations.

In some other examples, the communication parameter may be an example of an uplink transmission timing, downlink reception timing, RTT, or a combination thereof. As such, the network entity 105-b may identify a subset of uplink transmission timings, a subset of downlink reception timings, or a subset of RTTs for which the SBFD configuration is applicable for the wireless communications 310. Accordingly, the network entity 105-b may indicate such subsets to the UEs 115, where the UEs 115 may determine, based on respective uplink transmission timings, downlink reception timings, or RTTs, whether to use the SBFD configuration or the other configuration for the wireless communications 310.

In some examples, the communication parameter may be a TAG ID. For example, the network entity 105-b may identify a subset of TAG IDs for which the SBFD configuration is applicable and indicate the subset of TAG IDs to the UEs 115. The UEs 115 may determine whether to use the SBFD configuration or the other configuration based on whether the respective TAG IDs are included in the subset of TAG IDs.

In some examples, the communication parameter may be an output of an artificial intelligence or machine learning model. For example, the network entity 105-b and the UEs 115 may operate a same artificial intelligence or machine learning model, where the model may use as input a communication beam, beam direction, signal quality of the beam, geographical location, communication link type (e.g., whether the UE is under the coverage area of the network-controlled repeater 305), TAG ID, downlink reception timing, uplink reception timing, RTT, or any combination thereof. In such examples, the inputs to the model may be within a threshold amount of time (e.g., T seconds). The network entity 105-b may identify a subset of outputs of the model for which the SBFD configuration is applicable and indicate the subset of outputs to the UEs 115. Additionally, the network entity 105-b may indicate which inputs to use to operate the model. The UEs 115 may generate an output from the model using the one or more indicated inputs and determine whether to use the SBFD configuration or the other configuration based on whether the output generated at each UE is included in the subset of outputs for which the SBFD configuration is applicable.

In some examples, the communication parameter may be a zone (e.g., a geographic area having some boundary), where the network entity 105-b may explicitly indicate to the UEs 115 which zone the UEs 115 are operating in. For example, the network entity 105-b may generate various zones that span the coverage area of the network entity 105-b. The network entity 105-b may identify, based on generating the zones, a subset of zones for which the SBFD configuration is applicable. For example, the network entity 105-b may identify communication links in each zone and identify the subset of zones for which the SBFD configuration is applicable based on the type of communication links in each zone.

Accordingly, the network entity 105-b may indicate, via the control signals 315, the subset of zone in which the SBFD configuration is applicable. Additionally, the network entity 105-b may also transmit, via a signal 320, an indication of which zone in which each UE 115 is operating. For example, the network entity 105-b may transmit an indication that the UE 115-c is operating in a first zone, an indication the UE 115-d is operating in a second zone, and an indication the UE 115-e is operating in a third zone. As such, the UEs 115 may determine whether to use the SBFD configuration or the other configuration based on whether the indicated zone is included in the subset of zones for which the SBFD configuration is applicable.

FIG. 4 shows an example of a wireless communications system 400 that supports beam-based full-duplex configurations in accordance with one or more aspects of the present disclosure. Aspects of the wireless communications system 400 may implement, or be implemented by, aspects of the wireless communications system 100 and the wireless communications system 200 as described herein with reference to FIGS. 1 and 2. For example, the wireless communications system 400 may include a network entity 105-c and a network-controlled repeater 405, which may be examples of a network entity 105 and the network-controlled repeater 405 as described herein. Further, the wireless communications system 400 may include a UE 115-f, a UE 115-g, and a UE 115-h, which may be examples of UEs 115 described herein. The techniques described in the context of the wireless communications system 400 may enable the network entity 105 to indicate multiple SBFD configurations to the UEs 115 (e.g., SBFD aware UEs).

In some examples, the network entity 105-c may operate a MU-MIMO SBFD operation, where the network entity 105-c may communicate (e.g., serve) with the UE 115-h directly via a downlink (or uplink) subband and communicate with the UE 115-f via the network-controlled repeater 405 according to an uplink (or downlink) subband of an SBFD configuration. In some examples, the network-controlled repeater 405 may be SBFD capable and, as such, may be able to serve both the UE 115-f via a downlink subband and the UE 115-g via an uplink subband, simultaneously. In some other examples, the network entity 105-c may operate a MU-MIMO SBFD operation, in which the network entity 105-c may communicate with (e.g., serve) the UE 115-h via a direct link in a downlink (or uplink) subband and communicate with another UE via a RIS (not shown) in an uplink (or downlink) subband.

Accordingly, based on the capabilities or configuration of the network-controlled repeater 405, the RIS, or both, the network entity 105-c may identify multiple SBFD configurations, each with a different amount of guard-band, placement (in frequency) of the uplink and downlink subbands, and quantity of downlink subbands, for different communication links when the network-controlled repeater 405 is involved. That is, if the network entity 105-c identifies that some communication parameters (e.g., beams) may be associated with the network-controlled repeater 405 (or RIS) (e.g., the wireless repeater forwards signals associated with those beams or SSBs) and that the network-controlled repeater 405 supports SBFD operations, then the network entity 105-c may generate different SBFD configurations according to the network-controlled repeater 405 configuration, where each of the different SBFD configurations may be associated with a respective subset of communication parameters (e.g., each SBFD configuration may be beam-specific).

For example, based on the filtering capability of the network-controlled repeater 405, an amplification gain in the uplink and downlink subbands, the internal delay, a backhaul propagation to the network entity 105-c, a level of spatial isolation between transmission and reception antenna ports (to make the amount of SI, CLI, and leakage to adjacent resource blocks (RBs)) may be different at the network-controlled repeater 405. As such, based on such characteristics, the network entity 105-c may generate different SBFD configurations, such that the downlink subband, uplink subband, and guard band of the SBFD configuration for the communication link including the network-controlled repeater 405 (or RIS) may be different than those of an SBFD configuration for a direct link under the coverage of the network entity 105-c.

As an illustrative example, if the network-controlled repeater 405 (or RIS) supports SBFD operations, the network entity 105-c may generate a first SBFD configuration for the communication link including the network-controlled repeater and generate a second, different, SBFD configuration for the direct link with the UE 115-h. As such, the location and size of the uplink subbands, downlink subbands, guard bands, for each SBFD configuration may be different.

As such, because the network-controlled repeater 405 may support SBFD operations, the network entity 105-c may indicate, to the UEs 115, multiple SBFD configurations and respective subsets of communication parameters in which each of the multiple SBFD configurations is applicable. In such examples, each SBFD configuration may be a cell common semi-static time and frequency SBFD configuration. Accordingly, the UEs 115 under the coverage of different directions (e.g., supporting or not supporting SBFD operation) may receive the cell common semi-static time and frequency configuration. That is, UEs 115 operating under a communication link that does not support SBFD operation may receive an indication of the SBFD configuration.

The network entity 105-c may identify multiple SBFD configurations and respective subsets of communication parameters for which each SBFD configuration is applicable. In such examples, the network entity 105-c may identify the SBFD configurations according to the respective communication links between the UEs 115 and the network entity 105-c. The network entity 105-c may transmit, via control signals 415 (e.g., the control signal 415-a and the control signal 415-b), indications of the multiple SBFD configurations and the respective subsets of communication parameters. As such, for wireless communications 310 associated with one of the respective subsets of communication parameters, by an implicit rule, the UEs 115 may apply the respective semi-static SBFD configuration for the wireless communications 310.

As an illustrative example, the network entity 105-c may generate two SBFD configurations, a first SBFD configuration corresponding to the communication link that includes the network-controlled repeater 405 and the second SBFD configuration corresponding to the direct communication link with the UE 115-h. The network entity 105-c may identify a first subset of communication parameters for which the first SBFD configuration is applicable and identify a second subset of communication parameters for which the second SBFD configuration is applicable and indicate the SBFD configurations and the respective sets of communication parameters to the UEs 115.

As such, the UE 115-f may determine to use the first SBFD configuration based on a communication parameter associated with the wireless communication 410-a (e.g., using one or more messages including data and/or control information) being including the first subset of communication parameters corresponding to the first SBFD configuration. Similarly, the UE 115-g may determine to use the first SBFD configuration based on a communication parameter associated with the wireless communication 410-b (e.g., using one or more messages including data and/or control information) being included in the first subset of communication parameters. The UE 115-h may determine to use the second SBFD configuration based on a communication parameter associated with the wireless communication 410-c being included the second subset of communication parameters corresponding to the second SBFD configuration.

In some examples, in addition to transmitting the control signal 415, the network entity 105-c may indicate, via a signal 420 (e.g., the signal 420-a and the signal 420-b), which SBFD configuration to use for the wireless communication 410. That is, for wireless communications 410 (e.g., transmissions or receptions) associated with one of the respective subsets of communication parameters, the UEs 115 may receive, via the signal 420, an index or ID of the SBFD configuration for which the UEs 115 are to use for the wireless communications 410.

In such examples, the signal 420 (e.g., explicit indication) may be a respective scheduling DCI associated with each of the wireless communications 410. In some other examples, the signal 420 may be a respective RRC signal indicating the persistent or semi-persistent for each of the wireless communications 410. Additionally, or alternatively, the signal 420 may be a MAC-CE associated with the wireless communications 410.

As an illustrative example, the network entity 105-c may indicate, via the control signals 415, the first SBFD configuration associated with the first subset of communication parameters and the second SBFD configuration associated with a second subset of communication parameters. The network entity 105-c may transmit, via the signal 420-a, an index of one or an ID associated with the first SBFD configuration, such that the UE 115-f and the UE 115-g use the first SBFD configuration for the wireless communication 410-a and 410-b. Similarly, the network entity 105-c may transmit, via the signal 42-b, an index of two or an ID associated with the second SBFD configuration, such that the UE 115-h uses the second SBFD configuration for the wireless communication 410-c.

In some examples, whether one or more channels, such as RACH, PRACH, RMSI PDCCH, RMSI PDSCH, paging PDCCH, or paging PDSCH, or one or more reference signals, such as SSBs, are supported within SBFD symbols may be based on the communication parameters associated with the wireless communications 410 (e.g., be based on the beams used by the UEs 115). That is, whether SBFD operation is supported in symbols overlapping with such reference signals or channels may be based on the communication parameter associated with the wireless communications 410.

For example, the UEs 115 may determine whether to use one of the multiple SBFD configurations or another configuration (e.g., half-duplex configuration) based on whether time and frequency resources of the one or more channels, of the one or more reference signals, or both, at least partially overlap with the time and frequency resources of the respective SBFD configuration. In some examples, for overlapping resources, by an implicit rule, the UEs 115 may drop or ignore the SBFD configuration and use the other configuration for the wireless communications 410 (e.g., follow legacy UE behaviors).

As an illustrative example, the UE 115-f may determine that the time and frequency resources of the first SBFD configuration partially overlap with time and frequency resources of the one or more channels, the one or more reference signals, or both. Accordingly, the UE 115-f may drop the first SFBD configuration and use the other configuration for the wireless communication 410-a. Alternatively, if the time and frequency resources of the first SBFD configuration do not overlap with those of the one or more channels, the one or more reference signals, or both, and the communication parameter of the wireless communication 410-a is included in the first subset of communication parameters, then the UE 115-f may utilize the first SBFD configuration for the wireless communication 410-a.

In some other examples, for overlapping resources, the UEs 115 may receive an explicit indication to drop or ignore the respective SBFD configuration and use the other configuration for the wireless communications 410 (e.g., follow legacy UE behaviors). The indication may be configuration signaling of the common channels, configuration signaling of the one or more reference signals, or both. For example, the time and frequency resources of the first SBFD configuration may at least partially overlap with those of one or more channels, one or more reference signals, or both. Accordingly, the network entity 105-c may transmit, via the signal 420-a to the UE 115-f, an indication for the UE 115-f to drop the first SBFD configuration and use the other configuration for the wireless communication 410-a.

As described herein, the communication parameter may be one or more beams and associated beam directions. Accordingly, the network entity 105-c may perform the SBFD operation based on beam-specific SBFD configurations. For example, the network entity 105-c may identify multiple SBFD configurations based on the communication links between the network entity 105-c and the UEs 115. Based on generating the SBFD configurations, the network entity 105-c may identify respective subsets of beams and beam directions for which each SBFD configuration is applicable for wireless communications 410. In such examples, the network entity 105-c may identify a first subset of beams and beam directions associated with communications with the UE 115-f and UE 115-g and associate a first SBFD configuration with the first subset of beams and beam directions, where the first SBFD configuration was generated for the network-controlled repeater 405. Similarly, the network entity 105-c may identify a second subset of beams and beam directions associated with communications with the UE 115-h and associate the second subset beams and beam directions with a second SBFD configuration, where the second SBFD configuration is for a direct communication link.

As such, the network entity 105-c may transmit, via the control signals 415, an indication of the multiple SBFD configurations and an indication of the respective subsets of beam directions for which each SBFD configuration is applicable. To indicate the subset of beams and beam directions, the network entity 105-c may include, in the control signal, SSB indices, downlink TCI states, uplink TCI states, spatial relationships, or any combination thereof.

Based on the respective subsets of beams and beam directions and a beam direction of the respective wireless communications 410, the UEs 115 may determine which of the multiple SBFD configurations to use for the respective wireless communications 410. For example, the UE 115-f may determine that the beam and beam direction associated with receiving the wireless communication 410-a is included in the first subset of beams and beam directions. Accordingly, the UE 115-f may receive the wireless communication 410-a, via the beam, according to the resources of first SBFD configuration.

Similarly, the UE 115-g may determine that the beam and beam direction of the wireless communication 410-b is included in the first subset of beams and beam directions. As such, the UE 115-g may transmit the wireless communication 410-b via the beam and according to the resources of the first SBFD configuration. The UE 115-h may determine that the beam and beam direction used for the wireless communication 410-c is included in the second subset of beams and beam directions. As such, the UE 115-d and the UE 115-e may receive the wireless communication 410-c using the beam according to the resources of the second SBFD configuration.

In some examples, the communication parameter may be an example of signal thresholds of one or more beams. For example, the network entity 105-c may measure the signal quality of the beams used to communicate with each of the UEs 115. Based on the signal qualities, the network entity 105-c may identify a respective signal quality threshold for which each of the multiple SBFD configurations is applicable. Accordingly, the network entity 105-c may indicate the respective signal quality thresholds and multiple SBFD configurations to the UEs 115, where the UEs 115 may measure the respective signal qualities. Accordingly, the UEs 115 may compare the measured signal qualities to each of the signal quality thresholds to determine which SBFD configuration to use for the wireless communications 410.

In some other examples, the communication parameter may be an example of a geographical location. For example, the network entity 105-c may identify the coverage area of the network-controlled repeater 405 and determine that UEs 115 under such a coverage area may use a first SBFD configuration. As such, the network entity 105-c may associate a first subset of geographical locations (corresponding to the coverage area of the network-controlled repeater 405) with the first SBFD configuration. Similarly, the network entity 105-c may identify UEs 115 that have a direct communication link to the network entity 105-c and determine that such UEs 115 use a second SBFD configuration. Accordingly, the network entity 105-c may associate a second subset of geographical locations with the coverage area (corresponding to the direct links) with the second SBFD configuration. The network entity 105-c may indicate the two subsets of geographical locations to the UEs 115, where the UEs 115 may determine which SBFD configuration to use for the wireless communications 410 based on whether a geographical location of the UE 115 is included in the first subset of geographical locations or the second subset of geographical locations.

In some other examples, the communication parameter may be an example of an uplink transmission timing, downlink reception timing, RTT, or a combination thereof. As such, the network entity 105-c may identify multiple subsets of uplink transmission timings, downlink reception timings, or RTTs for which each of the SBFD configurations is applicable for the wireless communications 410. Accordingly, the network entity 105-c may indicate such subsets to the UEs 115, where the UEs 115 may determine, based on respective uplink transmission timings, downlink reception timings, or RTTs, which SBFD configurations to use for the wireless communications 410.

In some examples, the communication parameter may be a TAG ID. For example, the network entity 105-c may identify multiple subsets of TAG IDs for which each SBFD configuration is applicable and indicate the multiple subsets of TAG IDs to the UEs 115. The UEs 115 may determine which SBFD configuration to use based on the respective TAG IDs and the multiple subsets of TAG IDs.

In some examples, the communication parameter may be an output of an artificial intelligence or machine learning model. For example, the network entity 105-c and the UEs 115 may operate a same artificial intelligence or machine learning model, where the model may use as input a communication beam, beam direction, signal quality of the beam, geographical location, communication link type (e.g., whether the UE is under the coverage area of the network-controlled repeater 405), TAG ID, downlink reception timing, uplink reception timing, RTT, or any combination thereof. In such examples, the inputs to the model may be within a threshold amount of time (e.g., T seconds). The network entity 105-c may identify multiple subsets of outputs of the model for which each SBFD configuration is applicable and indicate the multiple subsets of outputs to the UEs 115. Additionally, the network entity 105-c may indicate which inputs to use to operate the model. The UEs 115 may generate respective outputs from the model using the one or more indicated inputs and determine which SBFD configuration of the multiple to use based on the respective outputs generated at each UE and the multiple subsets of outputs.

In some examples, the communication parameter may be a zone, where the network entity 105-c may explicitly indicate to the UEs 115 which zone the UEs 115 are operating in. For example, the network entity 105-c may generate various zones that span the coverage area of the network entity 105-c. The network entity 105-c may identify, based on generating the zones, multiple subsets of zones for which each of the multiple SBFD configurations is applicable. For example, the network entity 105-c may identify communication links in each zone and identify multiple subsets of zones for which each SBFD configuration is applicable based on the type of communication links in each zone.

Accordingly, the network entity 105-c may indicate, via the control signals 415, the multiple subsets of zone. Additionally, the network entity 105-c may also transmit, via a signal 420, an indication of which zone in which each UE 115 is operating. For example, the network entity 105-c may transmit an indication that the UE 115-f and the UE 115-g are operating in a first zone and an indication the UE 115-h is operating in a second zone. As such, the UEs 115 may determine which SBFD configuration to use based on the indicated zone from the network entity 105-c and the subsets of zones.

FIG. 5 shows an example of a process flow 500 that supports beam-based full-duplex configurations in accordance with one or more aspects of the present disclosure. The process flow 500 may implement, or be implemented, by aspects of the wireless communications system 100, the wireless communications system 200, and the wireless communications system 300, with reference to FIGS. 1 through 3. For example, the process flow 500 may include a network entity 105-d and a UE 115-i, which may be examples of the network entities 105 and the UEs 115 as described herein. The techniques described in the context of the process flow 500 may enable the UE 115-i to determine whether to use a full-duplex configuration or another configuration based on a communication parameter of a wireless communication.

At 505, the network entity 105-d may identify a subset of communication parameters for which a full-duplex configuration (e.g., SBFD time and frequency resources, such as resources for an SBFD slot 215) is applicable for a wireless communication between the UE 115-i and the network entity 105-d. In such examples, the network entity 105-d may identify the subset of communication parameters according to the techniques described herein with reference to FIG. 3.

At 510, based on identifying the full-duplex configuration and the subset of communication parameters where the full-duplex configuration is applicable, the network entity 105-d may output (e.g., transmit) a control signal indicating the full-duplex configuration and indicating the subset of communication parameters. In some examples, if the UE 115-i is operating in an RRC active mode, the network entity 105-d may output an RRC message indicating the full-duplex configuration and the subset of communication parameters. Alternatively, if the UE 115-i is operating in an RRC inactive or idle mode, the network entity 105-d may output a SIB message indicating the full-duplex configuration and subset of communication parameters.

In some examples, at 515, the network entity 105-d may output a signal indicating for the UE 115-i to use another configuration (e.g., a half-duplex configuration, time and frequency resources of a half-duplex slot 210) based on a communication parameter of the wireless communication being excluded from the subset of communication parameters for which the full-duplex configuration is applicable. In such examples, the signal may be DCI, an RRC signal, or a MAC-CE. Accordingly, at 520, the UE 115-i may determine to use the other configuration for the wireless communication based on receiving the signal and drop the full-duplex configuration.

In some examples, the set of communication parameters may include a set of zones, as described herein with reference to FIG. 3. Accordingly, at 515, the UE 115-i may receive a signal indicating that the UE is operating within a first zone. Thus, at 520, the UE 115-i may determine whether to use the full-duplex configuration or half-duplex configuration based on whether the first zone is within the subset of zones for which the full-duplex configuration is applicable.

In some examples, at 515, the UE 115-i may receive a signal that indicates to use the other configuration for the wireless communication based on the time and frequency resources of the full-duplex configuration at least partially overlapping with one or more channels (e.g., PDCCH, PDSCH, RACH, paging channels), one or more reference signals, or both. Accordingly, at 520, the UE 115-i may drop the full-duplex configuration and apply the other configuration for the wireless communication based on the signal.

Alternatively, at 520 and based on receiving the control signal at 510, the UE 115-i may determine whether to use the full-duplex configuration or the other configuration for the wireless communication based on a communication parameter of the wireless communication and the subset of communication parameters associated with the full-duplex configuration. In some examples, the UE 115-i may determine to use the other configuration based on the communication parameter of the wireless communication being excluded from the subset of communication parameters. Accordingly, the UE 115-i may drop the full-duplex configuration based on the determination.

In some other examples, the UE 115-i may determine to use the full-duplex configuration for the wireless communication based on the communication parameter being included in the subset of communication parameters. In some examples, the UE 115-i may determine that the time and frequency resources of the full-duplex configuration overlap, at least partially, with one or more channels, one or more reference signals, or both. Accordingly, the UE 115-i may drop the full-duplex configuration.

In some examples, the UE 115-i may determine that the wireless repeater or RIS is associated with a communication link between the UE 115-i and the network entity 105-d. As such, the UE 115-i may drop the full-duplex configuration and determine to use the other configuration for the wireless communication.

At 525, the UE 115-i may communicate (e.g., transmit or receive) the wireless communication with the network entity 105-d based on the determining at 520.

FIG. 6 shows an example of a process flow 600 that supports beam-based full-duplex configurations in accordance with one or more aspects of the present disclosure. The process flow 600 may implement, or be implemented, by aspects of the wireless communications system 100, the wireless communications system 200, and the wireless communications system 400 with reference to FIGS. 1, 2, and 4. For example, the process flow 600 may include a network entity 105-e and a UE 115-j, which may be examples of the network entities 105 and the UEs 115 as described herein. The techniques described in the context of the process flow 600 may enable the UE 115-j to identify a first full-duplex configuration out of multiple full-duplex configurations based on a communication parameter of a wireless communication.

At 605, the network entity 105-e may identify multiple full-duplex configurations and a respective subset of communication parameters for which each of the multiple full-duplex configurations is applicable. The network entity 105-e may identify the multiple full-duplex configurations according to the techniques described herein with reference to FIG. 4.

At 610, the network entity 105-e may output a control signal indicating the multiple full-duplex configurations and the respective subsets of communication parameters. In such examples, if the UE 115-j is operating in a RRC active mode, the network entity 105-e may output an RRC message indicating the multiple full-duplex configurations and the respective subsets of communication parameters for which each full-duplex configuration is applicable. Alternatively, if the UE 115-j is operating in an RRC inactive or idle mode, the network entity 105-e may output a SIB message indicating the multiple full-duplex configurations and the respective subsets of communication parameters.

In some examples, at 615, the UE 115-j may receive a signal that indicates for the UE 115-j to use a first full-duplex configuration of the multiple full-duplex configuration based on a communication parameter associated with the wireless communication being included in a first subset of communication parameters associated with the first full-duplex configuration. Accordingly, at 620, the UE 115-j may identify the first full-duplex configuration based on the signal. In such examples, the signal may be an RRC message, DCI, or a MAC-CE.

In some examples, at 615, the UE 115-j may receive a signal indicating to use another configuration (e.g., a half-duplex configuration or resources associated with a half-duplex slot 210) based on the time and frequency resources of a first full-duplex configuration at least partially overlapping with one or more channels (e.g., RACH, PDCCH, PDSCH), one or more reference signals, or both. Accordingly, at 620, the UE 115-j may drop the first full-duplex configuration and determine to use the other configuration.

In some examples, the set of communication parameters may be a set of zones. Accordingly, at 615, the UE 115-j may receive a signal indicating that the UE 115-j is operating within a first zone of the set of zones. As such, at 620, the UE 115-j may identify a first full-duplex configuration based on the first zone indicated via the signal being included in a subset of zones associated with the first full-duplex configuration.

Alternatively, at 620 and in response to receiving the control signal at 610, the UE 115-j may identify, from the multiple full-duplex configurations, a first full-duplex configuration based on the communication parameter associated with the wireless communication being included in a first subset of communication parameters corresponding to the first full-duplex configuration. In some examples, based on identifying the first full-duplex configuration, the UE 115-j may determine that the time and frequency resources of the first full-duplex configuration at least partially overlap with the one or more channels, with the one or more reference signals, or both. Accordingly, the UE 115-j may determine to drop the first full-duplex configuration based on the determination.

At 625, the UE 115-j and the network entity 105-e may communicate in accordance with the communication parameter of the wireless communication and based on the first full-duplex configuration or another configuration. That is, the UE 115-j may use the configuration determined at 620 to communicate the wireless communication.

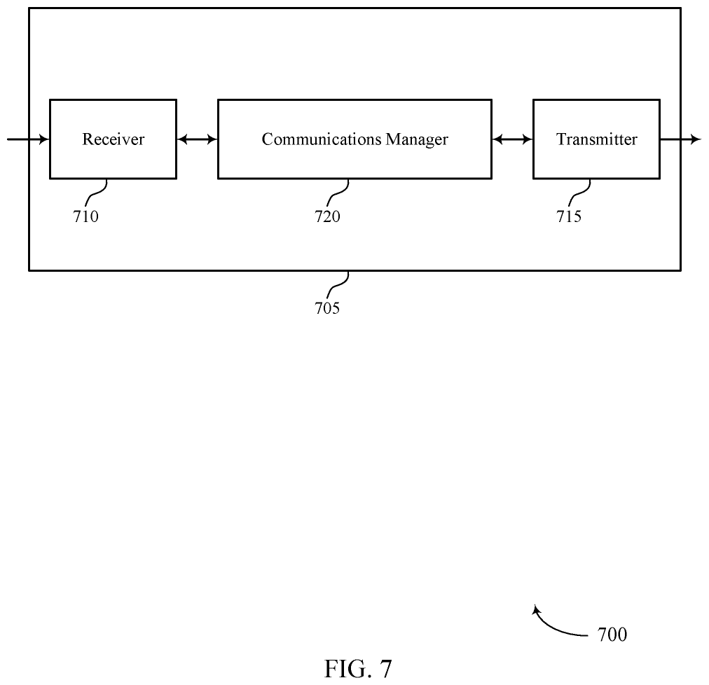

FIG. 7 shows a block diagram 700 of a device 705 that supports beam-based full-duplex configurations in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to beam-based full-duplex configurations). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to beam-based full-duplex configurations). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of beam-based full-duplex configurations as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software) executed by at least one processor. If implemented in code executed by at least one processor, the functions of the communications manager 720, the receiver 710, the transmitter 715, or various combinations or components thereof may be performed by a general-purpose processor, a DSP, a CPU, a GPU, a NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity. The communications manager 720 is capable of, configured to, or operable to support a means for determining whether to use the full-duplex configuration or another configuration for wireless communication with the network entity based on a communication parameter associated with the wireless communication and the subset of communication parameters associated with the full-duplex configuration. The communications manager 720 is capable of, configured to, or operable to support a means for communicating with the network entity in accordance with the communication parameter and based on the determining.

Additionally, or alternatively, the communications manager 720 may support wireless communications in accordance with examples as disclosed herein. For example, the communications manager 720 is capable of, configured to, or operable to support a means for receiving a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity. The communications manager 720 is capable of, configured to, or operable to support a means for identifying, from the set of multiple full-duplex configurations, a first full-duplex configuration for wireless communication with the network entity based on a communication parameter associated with the wireless communication being included in a first subset of communication parameters corresponding to the first full-duplex configuration. The communications manager 720 is capable of, configured to, or operable to support a means for communicating with the network entity in accordance with the communication parameter and based on the first full-duplex configuration or another configuration.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for indicating beam-specific SBFD configuration, which may provide for a more efficient utilization of communication resources.

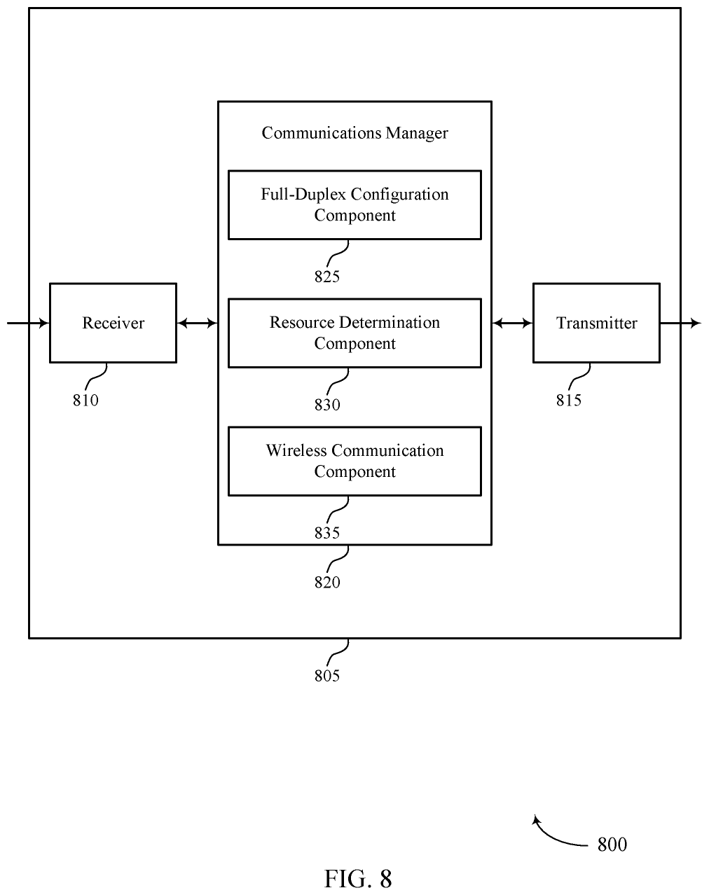

FIG. 8 shows a block diagram 800 of a device 805 that supports beam-based full-duplex configurations in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to beam-based full-duplex configurations). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to beam-based full-duplex configurations). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of beam-based full-duplex configurations as described herein. For example, the communications manager 820 may include a full-duplex configuration component 825, a resource determination component 830, a wireless communication component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The full-duplex configuration component 825 is capable of, configured to, or operable to support a means for receiving a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity. The resource determination component 830 is capable of, configured to, or operable to support a means for determining whether to use the full-duplex configuration or another configuration for wireless communication with the network entity based on a communication parameter associated with the wireless communication and the subset of communication parameters associated with the full-duplex configuration. The wireless communication component 835 is capable of, configured to, or operable to support a means for communicating with the network entity in accordance with the communication parameter and based on the determining.

Additionally, or alternatively, the communications manager 820 may support wireless communications in accordance with examples as disclosed herein. The full-duplex configuration component 825 is capable of, configured to, or operable to support a means for receiving a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity. The resource determination component 830 is capable of, configured to, or operable to support a means for identifying, from the set of multiple full-duplex configurations, a first full-duplex configuration for wireless communication with the network entity based on a communication parameter associated with the wireless communication being included in a first subset of communication parameters corresponding to the first full-duplex configuration. The wireless communication component 835 is capable of, configured to, or operable to support a means for communicating with the network entity in accordance with the communication parameter and based on the first full-duplex configuration or another configuration.

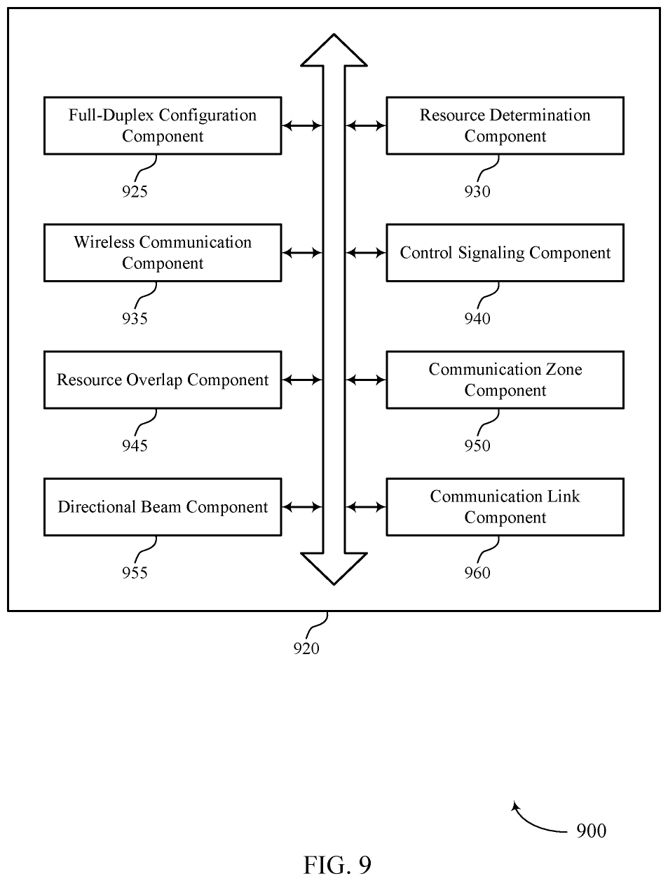

FIG. 9 shows a block diagram 900 of a communications manager 920 that supports beam-based full-duplex configurations in accordance with one or more aspects of the present disclosure. The communications manager 920 may be an example of aspects of a communications manager 720, a communications manager 820, or both, as described herein. The communications manager 920, or various components thereof, may be an example of means for performing various aspects of beam-based full-duplex configurations as described herein. For example, the communications manager 920 may include a full-duplex configuration component 925, a resource determination component 930, a wireless communication component 935, a control signaling component 940, a resource overlap component 945, a communication zone component 950, a directional beam component 955, a communication link component 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The full-duplex configuration component 925 is capable of, configured to, or operable to support a means for receiving a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity. The resource determination component 930 is capable of, configured to, or operable to support a means for determining whether to use the full-duplex configuration or another configuration for wireless communication with the network entity based on a communication parameter associated with the wireless communication and the subset of communication parameters associated with the full-duplex configuration. The wireless communication component 935 is capable of, configured to, or operable to support a means for communicating with the network entity in accordance with the communication parameter and based on the determining.

In some examples, the control signaling component 940 is capable of, configured to, or operable to support a means for receiving a signal including an indication to use the other configuration based on the communication parameter being excluded from the subset of communication parameters, where communicating with the network entity is based on the other configuration.

In some examples, the resource determination component 930 is capable of, configured to, or operable to support a means for dropping the full-duplex configuration based on the indication to use the other configuration.

In some examples, the signal includes one of DCI, a RRC message, or a MAC-CE.

In some examples, to support determining, the resource determination component 930 is capable of, configured to, or operable to support a means for determining to use the other configuration based on the communication parameter being excluded from the subset of communication parameters, where communicating with the network entity is based on the other configuration.

In some examples, the resource determination component 930 is capable of, configured to, or operable to support a means for dropping the full-duplex configuration based on the communication parameter being excluded from the subset of communication parameters.

In some examples, to support determining, the resource determination component 930 is capable of, configured to, or operable to support a means for determining to use the full-duplex configuration for the wireless communication based on the communication parameter being included in the subset of communication parameters, where communicating with the network entity is based on the full-duplex configuration.

In some examples, the resource overlap component 945 is capable of, configured to, or operable to support a means for determining that the time and frequency resources of the full-duplex configuration at least partially overlap with one or more channels, one or more reference signals, or any combination thereof, where determining whether to use the full-duplex configuration or the other configuration is further based on the time and frequency resources at least partially overlapping with the one or more channels, the one or more reference signals, or any combination thereof.

In some examples, the resource determination component 930 is capable of, configured to, or operable to support a means for dropping the full-duplex configuration based on the time and frequency resources at least partially overlapping with the one or more channels, the one or more reference signals, or any combination thereof, where communicating with the network entity is based on the other configuration.

In some examples, the control signaling component 940 is capable of, configured to, or operable to support a means for receiving a signal including an indication to use the other configuration based on the time and frequency resources at least partially overlapping with the one or more channels, the one or more reference signals, or any combination thereof. In some examples, the resource determination component 930 is capable of, configured to, or operable to support a means for dropping the full-duplex configuration based on the indication to use the other configuration, where communicating with the network entity is based on the other configuration.

In some examples, the signal including the indication is a second control signal configuring the one or more channels, a third control signal configuring the one or more reference signals, or any combination thereof.

In some examples, the one or more channels include a RACH, a RMSI PDCCH, an RMSI PDSCH, a paging PDCCH, a paging PDSCH, or any combination thereof.

In some examples, the UE is operating in a RRC inactive mode or a RRC idle mode, and the control signal includes a system information signal.

In some examples, the UE is operating in a RRC active mode, and the control signal includes a RRC message.

In some examples, the communication parameter includes one or more beams, one or more signal thresholds associated with the one or more beams, a beam direction of the wireless communication, a geographic location of the UE, a downlink reception timing, an uplink transmission timing, a round-trip-time of the wireless communication, one or more TAG identifiers, a type of communication link between the UE and the network entity, one or more outputs of a machine learning model, or any combination thereof.

In some examples, the beam direction of the wireless communication is associated with a synchronization signal block index, a downlink transmission configuration indicator state, an uplink transmission configuration indicator state, spatial relationship of one or more communication beams, or a combination thereof.

In some examples, the set of communication parameters include a set of zones, and the communication zone component 950 is capable of, configured to, or operable to support a means for receiving an indication that the UE is operating within a first zone of the set of zones, where determining whether to use the full-duplex configuration or the other configuration for the wireless communication is based on the indication that the UE is operating within the first zone.

In some examples, the communication parameter includes a directional beam, and the directional beam component 955 is capable of, configured to, or operable to support a means for receiving a signal including an indication to use the other configuration based on the directional beam being excluded from a subset of directional beams associated with the full-duplex configuration. In some examples, the communication parameter includes a directional beam, and the resource determination component 930 is capable of, configured to, or operable to support a means for dropping the full-duplex configuration based on the indication to use the other configuration, where communicating with the network entity is via the directional beam and based on the other configuration.

In some examples, the communication parameter includes a directional beam, and the resource determination component 930 is capable of, configured to, or operable to support a means for determining to use the other configuration based on the directional beam being excluded from a subset of directional beams associated with the full-duplex configuration. In some examples, the communication parameter includes a directional beam, and the resource determination component 930 is capable of, configured to, or operable to support a means for dropping the full-duplex configuration based on the directional beam being excluded from the subset of directional beams, where communicating with the network entity is via the directional beam and based on the other configuration.

In some examples, the communication link component 960 is capable of, configured to, or operable to support a means for determining that a wireless repeater or RIS, or both, is associated with the communication link between the UE and the network entity, where determining to use the other configuration is based on the wireless repeater or the RIS, or both, being associated with the communication link.

In some examples, the time and frequency resources associated with the full-duplex configuration include one or more subbands allocated for downlink communications and one or more subbands allocated for uplink communications.

In some examples, the communication parameter is excluded from the subset of communication parameters based on a wireless repeater or a RIS, or both, being associated with the communication link between the UE and the network entity. In some examples, determining whether to use the full-duplex configuration or the other configuration is based on the wireless repeater or the RIS, or both, being associated with the communication link between the UE and the network entity.

Additionally, or alternatively, the communications manager 920 may support wireless communications in accordance with examples as disclosed herein. In some examples, the full-duplex configuration component 925 is capable of, configured to, or operable to support a means for receiving a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity. In some examples, the resource determination component 930 is capable of, configured to, or operable to support a means for identifying, from the set of multiple full-duplex configurations, a first full-duplex configuration for wireless communication with the network entity based on a communication parameter associated with the wireless communication being included in a first subset of communication parameters corresponding to the first full-duplex configuration. In some examples, the wireless communication component 935 is capable of, configured to, or operable to support a means for communicating with the network entity in accordance with the communication parameter and based on the first full-duplex configuration or another configuration.

In some examples, the control signaling component 940 is capable of, configured to, or operable to support a means for receiving a signal including an indication to use the first full-duplex configuration based on the communication parameter associated with the wireless communication being included in the first subset of communication parameters, where identifying the first full-duplex configuration is based on the indication to use the first full-duplex configuration.

In some examples, the signal includes an index of the first full-duplex configuration, an identifier associated with the first full-duplex configuration, or both. In some examples, the signal is one of a RRC message, DCI, or a MAC-CE.

In some examples, the resource overlap component 945 is capable of, configured to, or operable to support a means for determining that the respective time and frequency resources of the first full-duplex configuration at least partially overlap with one or more channels, one or more reference signals, or any combination thereof. In some examples, the resource determination component 930 is capable of, configured to, or operable to support a means for determining whether to use the first full-duplex configuration or the other configuration based on the respective time and frequency resources at least partially overlapping with the one or more channels, the one or more reference signals, or any combination thereof.

In some examples, the resource determination component 930 is capable of, configured to, or operable to support a means for dropping the first full-duplex configuration based on the respective time and frequency resources at least partially overlapping with the one or more channels, the one or more reference signals, or any combination thereof, where communicating with the network entity is based on the other configuration.

In some examples, the control signaling component 940 is capable of, configured to, or operable to support a means for receiving a signal including an indication to use the other configuration based on the respective time and frequency resources at least partially overlapping with the one or more channels, the one or more reference signals, or any combination thereof. In some examples, the resource determination component 930 is capable of, configured to, or operable to support a means for dropping the first full-duplex configuration based on the indication to use the other configuration, where communicating with the network entity is based on the other configuration.

In some examples, the signal including the indication is a second control signal configuring the one or more channels, a third control signal configuring the one or more reference signals, or any combination thereof. In some examples, the one or more channels include a RACH, a RMSI PDCCH, an RMSI PDSCH, a paging PDCCH, a paging PDSCH, or any combination thereof. In some examples, the UE is operating in a RRC inactive mode or a RRC idle mode, and the control signal includes a system information block. In some examples, the UE is operating in a RRC active mode, and the control signal includes a RRC message.

In some examples, the communication parameter includes one or more beams, one or more signal thresholds associated with the one or more beams, a beam direction of the wireless communication, a geographic location of the UE, a downlink reception timing, an uplink transmission timing, a round-trip-time of the wireless communication, one or more TAG identifiers, a type of communication link between the UE and the network entity, one or more outputs of a machine learning model, or any combination thereof.

In some examples, the beam direction of the wireless communication is associated with a synchronization signal block index, a downlink transmission configuration indicator state, an uplink transmission configuration indicator state, a spatial relations of one or more communication beams, or a combination thereof.

In some examples, the set of communication parameters include a set of zones, and the communication zone component 950 is capable of, configured to, or operable to support a means for receiving an indication that the UE is operating within a first zone of the set of zones, where determining whether to use the first full-duplex configuration or the other configuration for the wireless communication is based on the indication.

In some examples, the communication parameter includes a directional beam, and the directional beam component 955 is capable of, configured to, or operable to support a means for receiving a signal including an indication to use the first full-duplex configuration based on the directional beam being included in a subset of directional beams associated with the first full-duplex configuration, where communicating with the network entity is via the directional beam and based on the first full-duplex configuration.

In some examples, the communication parameter includes a directional beam, and the resource determination component 930 is capable of, configured to, or operable to support a means for determining to use the first full-duplex configuration based on the directional beam being included in a subset of directional beams associated with the first full-duplex configuration, where communicating with the network entity is via the directional beam and based on the first full-duplex configuration.

In some examples, the communication link component 960 is capable of, configured to, or operable to support a means for determining that a wireless repeater or a RIS, or both, is associated with the communication link between the UE and the network entity, where determining to use the first full-duplex configuration is based on the wireless repeater or the RIS, or both, being associated with the communication link.

In some examples, the time and frequency resources associated with the full-duplex configuration include one or more subbands allocated for downlink communications and one or more subbands allocated for uplink communications.

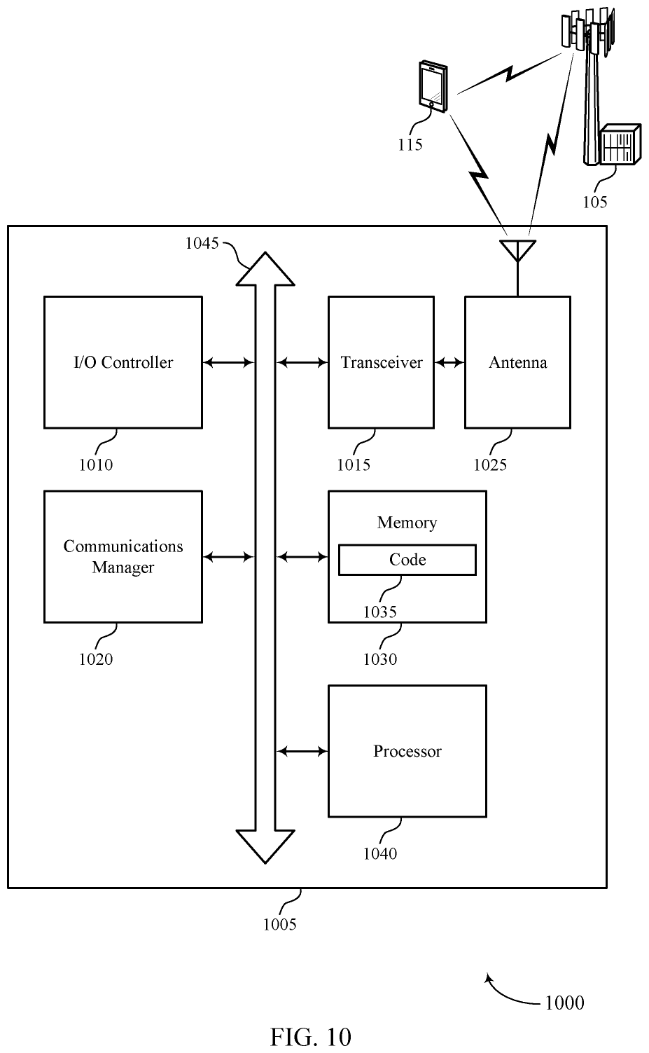

FIG. 10 shows a diagram of a system 1000 including a device 1005 that supports beam-based full-duplex configurations in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a GPU, a NPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting beam-based full-duplex configurations). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity. The communications manager 1020 is capable of, configured to, or operable to support a means for determining whether to use the full-duplex configuration or another configuration for wireless communication with the network entity based on a communication parameter associated with the wireless communication and the subset of communication parameters associated with the full-duplex configuration. The communications manager 1020 is capable of, configured to, or operable to support a means for communicating with the network entity in accordance with the communication parameter and based on the determining.

Additionally, or alternatively, the communications manager 1020 may support wireless communications in accordance with examples as disclosed herein. For example, the communications manager 1020 is capable of, configured to, or operable to support a means for receiving a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity. The communications manager 1020 is capable of, configured to, or operable to support a means for identifying, from the set of multiple full-duplex configurations, a first full-duplex configuration for wireless communication with the network entity based on a communication parameter associated with the wireless communication being included in a first subset of communication parameters corresponding to the first full-duplex configuration. The communications manager 1020 is capable of, configured to, or operable to support a means for communicating with the network entity in accordance with the communication parameter and based on the first full-duplex configuration or another configuration.

By including or configuring the communications manager 1020 in accordance with examples as described herein, the device 1005 may support techniques for indicating beam-specific SBFD configuration, which may provide for a more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of beam-based full-duplex configurations as described herein, or the at least one processor 1040 and the at least one memory 1030 may be otherwise configured to, individually or collectively, perform or support such operations.

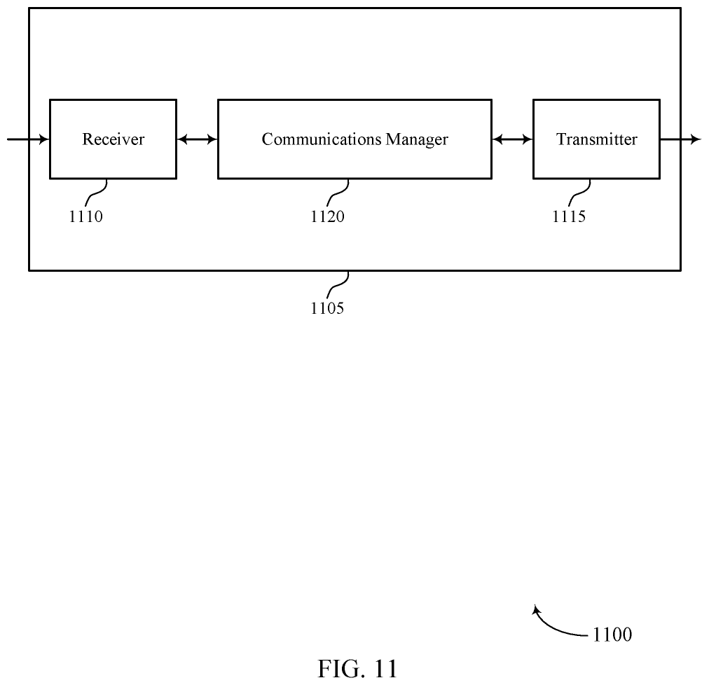

FIG. 11 shows a block diagram 1100 of a device 1105 that supports beam-based full-duplex configurations in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of beam-based full-duplex configurations as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, a GPU, a NPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software) executed by at least one processor. If implemented in code executed by at least one processor, the functions of the communications manager 1120, the receiver 1110, the transmitter 1115, or various combinations or components thereof may be performed by a general-purpose processor, a DSP, a CPU, a GPU, a NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for identifying a subset of communication parameters for which a full-duplex configuration is applicable for wireless communication between a UE and the network entity, the subset of communication parameters being from a set of communication parameters respectively associated with a communication link between the UE and the network entity. The communications manager 1120 is capable of, configured to, or operable to support a means for outputting a control signal indicating the full-duplex configuration and the subset of communication parameters, where the full-duplex configuration indicates time and frequency resources for full-duplex communications. The communications manager 1120 is capable of, configured to, or operable to support a means for communicating with the UE in accordance with a communication parameter associated with the wireless communication and based on the full-duplex configuration or another configuration.

Additionally, or alternatively, the communications manager 1120 may support wireless communications in accordance with examples as disclosed herein. For example, the communications manager 1120 is capable of, configured to, or operable to support a means for identifying a set of multiple full-duplex configurations and a respective subset of communication parameters for which each of the set of multiple full-duplex configurations is applicable, each respective subset of communication parameters being from a set of communication parameters associated with a communication link between a UE and the network entity. The communications manager 1120 is capable of, configured to, or operable to support a means for outputting a control signal indicating the set of multiple full-duplex configurations and the respective subsets of communication parameters, each of the set of multiple full-duplex configurations including time and frequency resources for full-duplex communications. The communications manager 1120 is capable of, configured to, or operable to support a means for communicating with the UE in accordance with a communication parameter and based on a first full-duplex configuration or another configuration.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for indicating beam-specific SBFD configuration, which may provide for a more efficient utilization of communication resources.

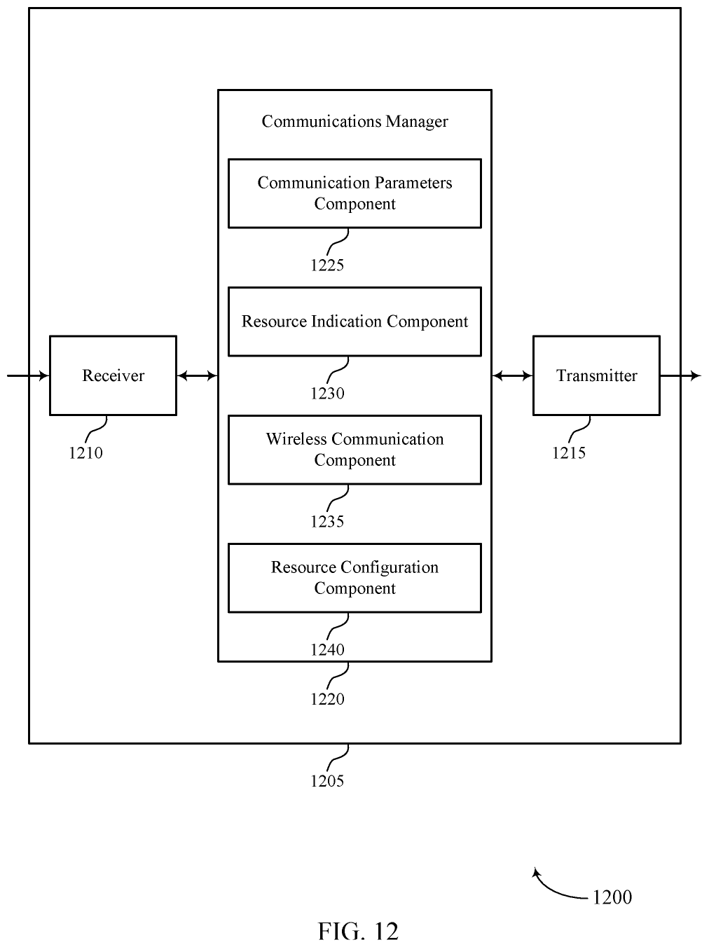

FIG. 12 shows a block diagram 1200 of a device 1205 that supports beam-based full-duplex configurations in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of beam-based full-duplex configurations as described herein. For example, the communications manager 1220 may include a communication parameters component 1225, a resource indication component 1230, a wireless communication component 1235, a resource configuration component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The communication parameters component 1225 is capable of, configured to, or operable to support a means for identifying a subset of communication parameters for which a full-duplex configuration is applicable for wireless communication between a UE and the network entity, the subset of communication parameters being from a set of communication parameters respectively associated with a communication link between the UE and the network entity. The resource indication component 1230 is capable of, configured to, or operable to support a means for outputting a control signal indicating the full-duplex configuration and the subset of communication parameters, where the full-duplex configuration indicates time and frequency resources for full-duplex communications. The wireless communication component 1235 is capable of, configured to, or operable to support a means for communicating with the UE in accordance with a communication parameter associated with the wireless communication and based on the full-duplex configuration or another configuration.

Additionally, or alternatively, the communications manager 1220 may support wireless communications in accordance with examples as disclosed herein. The resource configuration component 1240 is capable of, configured to, or operable to support a means for identifying a set of multiple full-duplex configurations and a respective subset of communication parameters for which each of the set of multiple full-duplex configurations is applicable, each respective subset of communication parameters being from a set of communication parameters associated with a communication link between a UE and the network entity. The resource indication component 1230 is capable of, configured to, or operable to support a means for outputting a control signal indicating the set of multiple full-duplex configurations and the respective subsets of communication parameters, each of the set of multiple full-duplex configurations including time and frequency resources for full-duplex communications. The wireless communication component 1235 is capable of, configured to, or operable to support a means for communicating with the UE in accordance with a communication parameter and based on a first full-duplex configuration or another configuration.

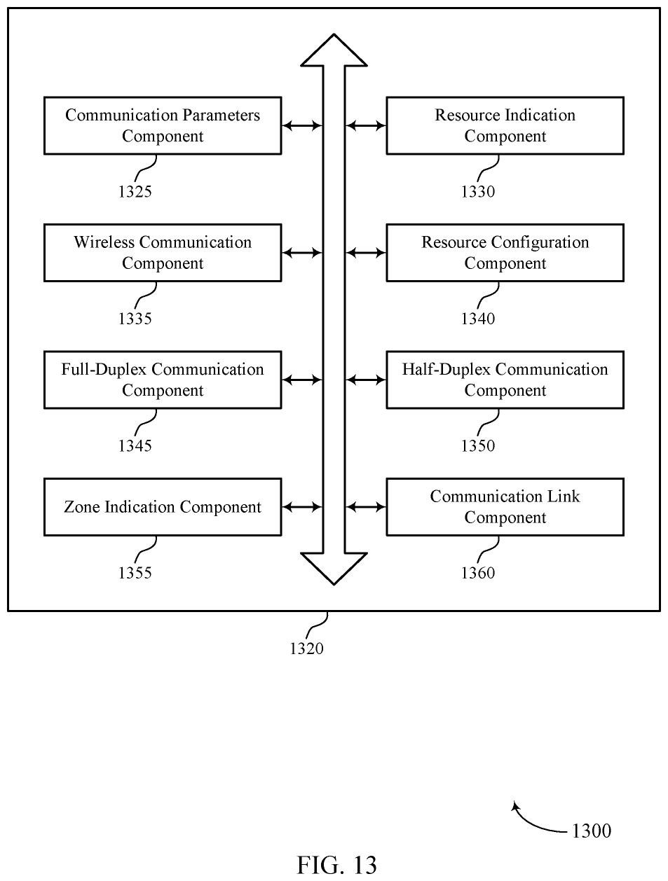

FIG. 13 shows a block diagram 1300 of a communications manager 1320 that supports beam-based full-duplex configurations in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of beam-based full-duplex configurations as described herein. For example, the communications manager 1320 may include a communication parameters component 1325, a resource indication component 1330, a wireless communication component 1335, a resource configuration component 1340, a full-duplex communication component 1345, a half-duplex communication component 1350, a zone indication component 1355, a communication link component 1360, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The communication parameters component 1325 is capable of, configured to, or operable to support a means for identifying a subset of communication parameters for which a full-duplex configuration is applicable for wireless communication between a UE and the network entity, the subset of communication parameters being from a set of communication parameters respectively associated with a communication link between the UE and the network entity. The resource indication component 1330 is capable of, configured to, or operable to support a means for outputting a control signal indicating the full-duplex configuration and the subset of communication parameters, where the full-duplex configuration indicates time and frequency resources for full-duplex communications. The wireless communication component 1335 is capable of, configured to, or operable to support a means for communicating with the UE in accordance with a communication parameter associated with the wireless communication and based on the full-duplex configuration or another configuration.

In some examples, the resource indication component 1330 is capable of, configured to, or operable to support a means for outputting a signal including an indication for the UE to use the other configuration based on the communication parameter being excluded from the subset of communication parameters, where communicating with the UE is based on the other configuration. In some examples, the signal is one of DCI, a RRC message, or MAC-CE.

In some examples, to support communicating, the full-duplex communication component 1345 is capable of, configured to, or operable to support a means for communicating with the UE according to the full-duplex configuration based on the communication parameter being included in the subset of communication parameters.

In some examples, to support communicating, the half-duplex communication component 1350 is capable of, configured to, or operable to support a means for communicating with the UE according to the other configuration based on the time and frequency resources of the full-duplex configuration at least partially overlapping with one or more channels, one or more reference signals, or any combination thereof.

In some examples, the resource indication component 1330 is capable of, configured to, or operable to support a means for outputting a signal including an indication to use the other configuration based on the time and frequency resources of the full-duplex configuration at least partially overlapping with the one or more channels, the one or more reference signals, or any combination thereof.

In some examples, the signal including the indication is a second control signal configuring the one or more channels, a third control signal configuring the one or more reference signals, or any combination thereof.

In some examples, the one or more channels include a RACH, a RMSI PDCCH, an RMSI PDSCH, a paging PDCCH, a paging PDSCH, or any combination thereof. In some examples, the UE is operating in a RRC inactive mode or a RRC idle mode, and the control signal includes a system information signal. In some examples, the UE is operating in a RRC active mode, and the control signal includes a RRC message.

In some examples, the communication parameter includes one or more beams, one or more signal threshold associated with the one or more beams, a beam direction of the wireless communication, a geographic location of the UE, a downlink reception timing, an uplink transmission timing, a round-trip-time of the wireless communication, one or more TAG identifiers, a type of communication link between the UE and the network entity, one or more outputs of a machine learning model, or any combination thereof.

In some examples, the beam direction of the wireless communication is associated with a synchronization signal block index, a downlink transmission configuration indicator state, an uplink transmission configuration indicator state, a spatial relations of one or more communication beams, or a combination thereof.

In some examples, the set of communication parameters are a set of zones, and the zone indication component 1355 is capable of, configured to, or operable to support a means for outputting an indication that the UE is operating within a first zone of the set of zones, where communicating with the UE is based on the indication that the UE is operating within the first zone.

In some examples, the communication link component 1360 is capable of, configured to, or operable to support a means for determining whether the UE is in coverage of a wireless repeater or a RIS, or both, where identifying the subset of communication parameters is based on determining whether the UE is in coverage of the wireless repeater or the RIS, or both. In some examples, the time and frequency resources associated with the full-duplex configuration include one or more subbands allocated for downlink communications and one or more subbands allocated for uplink communications.

Additionally, or alternatively, the communications manager 1320 may support wireless communications in accordance with examples as disclosed herein. The resource configuration component 1340 is capable of, configured to, or operable to support a means for identifying a set of multiple full-duplex configurations and a respective subset of communication parameters for which each of the set of multiple full-duplex configurations is applicable, each respective subset of communication parameters being from a set of communication parameters associated with a communication link between a UE and the network entity. In some examples, the resource indication component 1330 is capable of, configured to, or operable to support a means for outputting a control signal indicating the set of multiple full-duplex configurations and the respective subsets of communication parameters, each of the set of multiple full-duplex configurations including time and frequency resources for full-duplex communications. In some examples, the wireless communication component 1335 is capable of, configured to, or operable to support a means for communicating with the UE in accordance with a communication parameter and based on a first full-duplex configuration or another configuration.

In some examples, the resource indication component 1330 is capable of, configured to, or operable to support a means for outputting a signal including an indication to use the first full-duplex configuration based on the communication parameter associated with the wireless communication being included in the first subset of communication parameters, where communicating the wireless communication is based on the indication to use the first full-duplex configuration.

In some examples, the signal includes an index of the first full-duplex configuration, an identifier associated with the first full-duplex configuration, or both. In some examples, the signal is one of RRC message, DCI, or a MAC-CE.

In some examples, to support communicating, the half-duplex communication component 1350 is capable of, configured to, or operable to support a means for communicating with the UE according to the other configuration based on respective time and frequency resources of the first full-duplex configuration at least partially overlapping with one or more common channels, one or more reference signals, or any combination thereof.

In some examples, the resource indication component 1330 is capable of, configured to, or operable to support a means for outputting a signal including an indication to use the other configuration for the wireless communication based on the time and frequency resources of the first full-duplex configuration overlapping with the one or more common channels, the one or more reference signals, or any combination thereof.

In some examples, the signal including the indication is a second control signal configuring the one or more common channels, a third control signal configuring the one or more reference signals, or any combination thereof. In some examples, the one or more common channels include a RACH, a PDCCH, an PDSCH, a paging PDCCH, a paging PDSCH, or any combination thereof.

In some examples, the UE is operating in a RRC inactive mode or a RRC idle mode, and the control signal includes a system information block. In some examples, the UE is operating in a RRC active mode, and the control signal includes a RRC message.

In some examples, the communication parameter includes one or more beams, one or more signal threshold associated with the one or more beams, a beam direction of the wireless communication, a geographic location of the UE, a downlink reception timing, an uplink transmission timing, a round-trip-time of the wireless communication, one or more TAG identifiers, a type of communication link between the UE and the network entity, one or more outputs of a machine learning model, or any combination thereof.

In some examples, the beam direction of the wireless communication includes a synchronization signal block index, a downlink transmission configuration indicator state, an uplink transmission configuration indicator state, a spatial relations of one or more communication beams, or a combination thereof.

In some examples, the set of communication parameters are a set of zones, and the zone indication component 1355 is capable of, configured to, or operable to support a means for outputting an indication that the UE is operating within a first zone of the set of zones, where communicating the wireless communication is based on the indication.

In some examples, the communication link component 1360 is capable of, configured to, or operable to support a means for determining whether the UE is in coverage of a wireless repeater or a RIS, or both, where identifying the set of multiple full-duplex configurations is based on determining whether the UE is in coverage of the wireless repeater or the RIS, or both. In some examples, respective time and frequency resources associated with the full-duplex configuration include one or more subbands allocated for downlink communications and one or more subbands allocated for uplink communications.

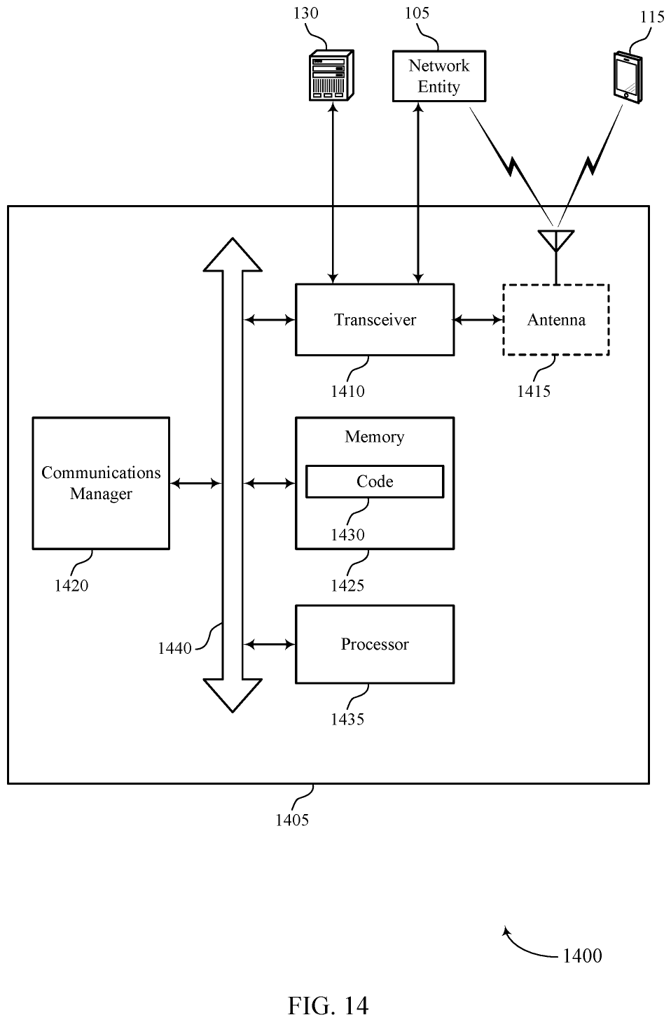

FIG. 14 shows a diagram of a system 1400 including a device 1405 that supports beam-based full-duplex configurations in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, a CPU, a NPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting beam-based full-duplex configurations). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for identifying a subset of communication parameters for which a full-duplex configuration is applicable for wireless communication between a UE and the network entity, the subset of communication parameters being from a set of communication parameters respectively associated with a communication link between the UE and the network entity. The communications manager 1420 is capable of, configured to, or operable to support a means for outputting a control signal indicating the full-duplex configuration and the subset of communication parameters, where the full-duplex configuration indicates time and frequency resources for full-duplex communications. The communications manager 1420 is capable of, configured to, or operable to support a means for communicating with the UE in accordance with a communication parameter associated with the wireless communication and based on the full-duplex configuration or another configuration.

Additionally, or alternatively, the communications manager 1420 may support wireless communications in accordance with examples as disclosed herein. For example, the communications manager 1420 is capable of, configured to, or operable to support a means for identifying a set of multiple full-duplex configurations and a respective subset of communication parameters for which each of the set of multiple full-duplex configurations is applicable, each respective subset of communication parameters being from a set of communication parameters associated with a communication link between a UE and the network entity. The communications manager 1420 is capable of, configured to, or operable to support a means for outputting a control signal indicating the set of multiple full-duplex configurations and the respective subsets of communication parameters, each of the set of multiple full-duplex configurations including time and frequency resources for full-duplex communications. The communications manager 1420 is capable of, configured to, or operable to support a means for communicating with the UE in accordance with a communication parameter and based on a first full-duplex configuration or another configuration.

By including or configuring the communications manager 1420 in accordance with examples as described herein, the device 1405 may support techniques for indicating beam-specific SBFD configuration, which may provide for a more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of beam-based full-duplex configurations as described herein, or the at least one processor 1435 and the at least one memory 1425 may be otherwise configured to, individually or collectively, perform or support such operations.

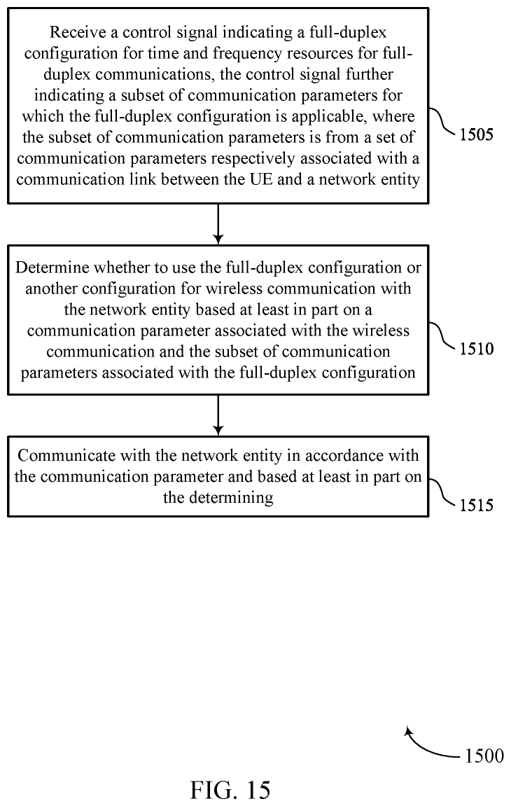

FIG. 15 shows a flowchart illustrating a method 1500 that supports beam-based full-duplex configurations in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity. The operations of 1505 may be performed in accordance with examples as disclosed herein. In some examples, aspects of the operations of 1505 may be performed by a full-duplex configuration component 925 as described with reference to FIG. 9.

At 1510, the method may include determining whether to use the full-duplex configuration or another configuration for wireless communication with the network entity based at least in part on a communication parameter associated with the wireless communication and the subset of communication parameters associated with the full-duplex configuration. The operations of 1510 may be performed in accordance with examples as disclosed herein. In some examples, aspects of the operations of 1510 may be performed by a resource determination component 930 as described with reference to FIG. 9.

At 1515, the method may include communicating with the network entity in accordance with the communication parameter and based at least in part on the determining. The operations of 1515 may be performed in accordance with examples as disclosed herein. In some examples, aspects of the operations of 1515 may be performed by a wireless communication component 935 as described with reference to FIG. 9.

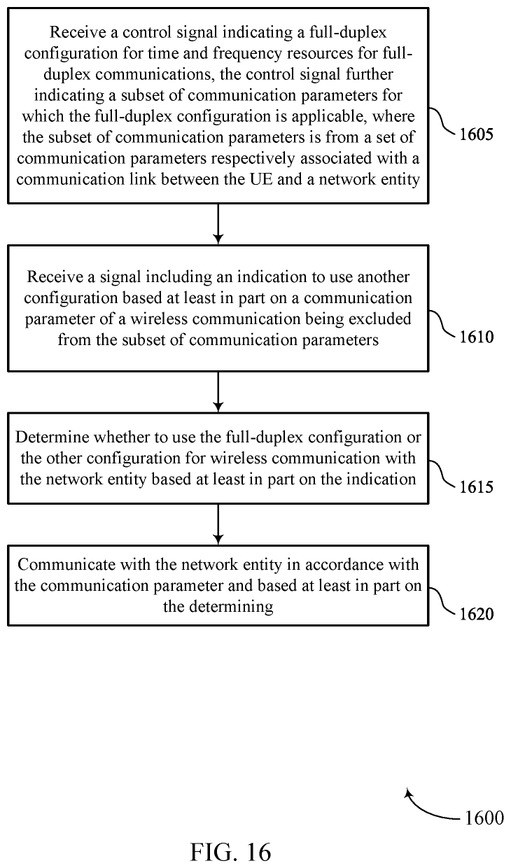

FIG. 16 shows a flowchart illustrating a method 1600 that supports beam-based full-duplex configurations in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a control signal indicating a full-duplex configuration for time and frequency resources for full-duplex communications, the control signal further indicating a subset of communication parameters for which the full-duplex configuration is applicable, where the subset of communication parameters is from a set of communication parameters respectively associated with a communication link between the UE and a network entity. The operations of 1605 may be performed in accordance with examples as disclosed herein. In some examples, aspects of the operations of 1605 may be performed by a full-duplex configuration component 925 as described with reference to FIG. 9.

At 1610, the method may include receiving a signal including an indication to use another configuration based at least in part on a communication parameter of a wireless communication being excluded from the subset of communication parameters. The operations of 1610 may be performed in accordance with examples as disclosed herein. In some examples, aspects of the operations of 1610 may be performed by a control signaling component 940 as described with reference to FIG. 9.

At 1615, the method may include determining whether to use the full-duplex configuration or another configuration for wireless communication with the network entity based at least in part on the indication. The operations of 1615 may be performed in accordance with examples as disclosed herein. In some examples, aspects of the operations of 1615 may be performed by a resource determination component 930 as described with reference to FIG. 9.

At 1620, the method may include communicating with the network entity in accordance with the communication parameter and based at least in part on the determining. The operations of 1620 may be performed in accordance with examples as disclosed herein. In some examples, aspects of the operations of 1620 may be performed by a wireless communication component 935 as described with reference to FIG. 9.

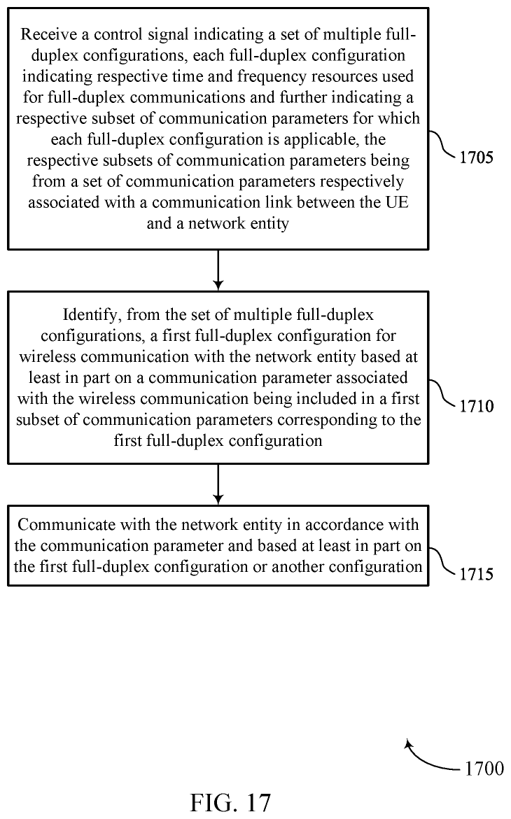

FIG. 17 shows a flowchart illustrating a method 1700 that supports beam-based full-duplex configurations in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity. The operations of 1705 may be performed in accordance with examples as disclosed herein. In some examples, aspects of the operations of 1705 may be performed by a full-duplex configuration component 925 as described with reference to FIG. 9.

At 1710, the method may include identifying, from the set of multiple full-duplex configurations, a first full-duplex configuration for wireless communication with the network entity based at least in part on a communication parameter associated with the wireless communication being included in a first subset of communication parameters corresponding to the first full-duplex configuration. The operations of 1710 may be performed in accordance with examples as disclosed herein. In some examples, aspects of the operations of 1710 may be performed by a resource determination component 930 as described with reference to FIG. 9.

At 1715, the method may include communicating with the network entity in accordance with the communication parameter and based at least in part on the first full-duplex configuration or another configuration. The operations of 1715 may be performed in accordance with examples as disclosed herein. In some examples, aspects of the operations of 1715 may be performed by a wireless communication component 935 as described with reference to FIG. 9.

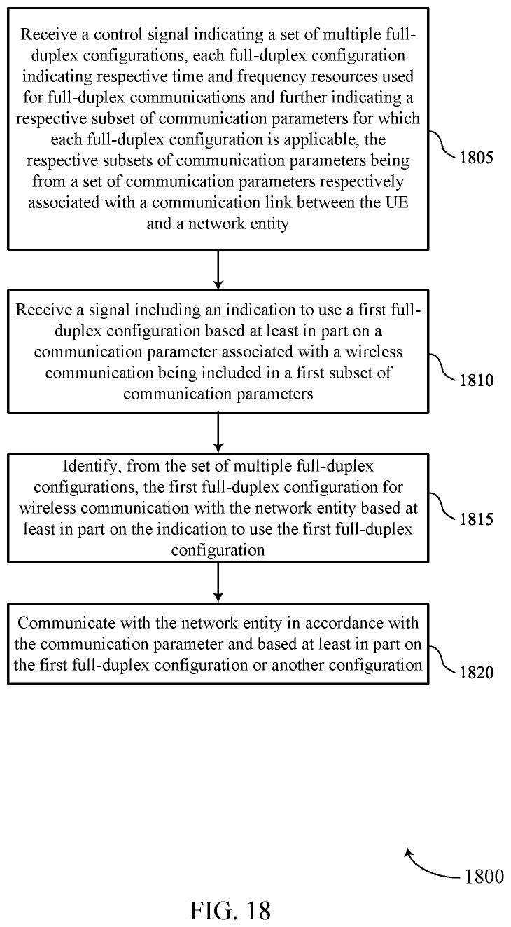

FIG. 18 shows a flowchart illustrating a method 1800 that supports beam-based full-duplex configurations in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving a control signal indicating a set of multiple full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity. The operations of 1805 may be performed in accordance with examples as disclosed herein. In some examples, aspects of the operations of 1805 may be performed by a full-duplex configuration component 925 as described with reference to FIG. 9.

At 1810, the method may include receiving a signal including an indication to use a first full-duplex configuration based at least in part on a communication parameter associated with a wireless communication being included in a first subset of communication parameters. The operations of 1810 may be performed in accordance with examples as disclosed herein. In some examples, aspects of the operations of 1810 may be performed by a control signaling component 940 as described with reference to FIG. 9.

At 1815, the method may include identifying, from the set of multiple full-duplex configurations, the first full-duplex configuration for wireless communication with the network entity based at least in part on the indication to use the first full-duplex configuration. The operations of 1815 may be performed in accordance with examples as disclosed herein. In some examples, aspects of the operations of 1815 may be performed by a resource determination component 930 as described with reference to FIG. 9.

At 1820, the method may include communicating with the network entity in accordance with the communication parameter and based at least in part on the first full-duplex configuration or another configuration. The operations of 1820 may be performed in accordance with examples as disclosed herein. In some examples, aspects of the operations of 1820 may be performed by a wireless communication component 935 as described with reference to FIG. 9.

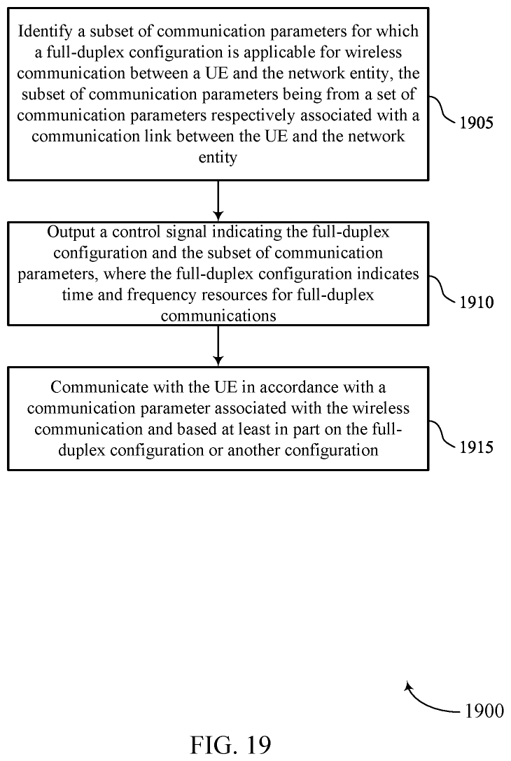

FIG. 19 shows a flowchart illustrating a method 1900 that supports beam-based full-duplex configurations in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include identifying a subset of communication parameters for which a full-duplex configuration is applicable for wireless communication between a UE and the network entity, the subset of communication parameters being from a set of communication parameters respectively associated with a communication link between the UE and the network entity. The operations of 1905 may be performed in accordance with examples as disclosed herein. In some examples, aspects of the operations of 1905 may be performed by a communication parameters component 1325 as described with reference to FIG. 13.

At 1910, the method may include outputting a control signal indicating the full-duplex configuration and the subset of communication parameters, where the full-duplex configuration indicates time and frequency resources for full-duplex communications. The operations of 1910 may be performed in accordance with examples as disclosed herein. In some examples, aspects of the operations of 1910 may be performed by a resource indication component 1330 as described with reference to FIG. 13.

At 1915, the method may include communicating with the UE in accordance with a communication parameter associated with the wireless communication and based at least in part on the full-duplex configuration or another configuration. The operations of 1915 may be performed in accordance with examples as disclosed herein. In some examples, aspects of the operations of 1915 may be performed by a wireless communication component 1335 as described with reference to FIG. 13.

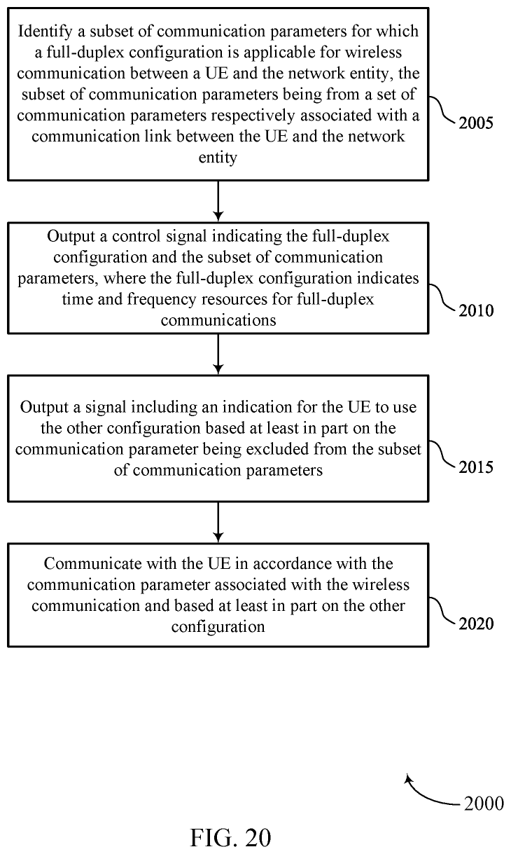

FIG. 20 shows a flowchart illustrating a method 2000 that supports beam-based full-duplex configurations in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include identifying a subset of communication parameters for which a full-duplex configuration is applicable for wireless communication between a UE and the network entity, the subset of communication parameters being from a set of communication parameters respectively associated with a communication link between the UE and the network entity. The operations of 2005 may be performed in accordance with examples as disclosed herein. In some examples, aspects of the operations of 2005 may be performed by a communication parameters component 1325 as described with reference to FIG. 13.

At 2010, the method may include outputting a control signal indicating the full-duplex configuration and the subset of communication parameters, where the full-duplex configuration indicates time and frequency resources for full-duplex communications. The operations of 2010 may be performed in accordance with examples as disclosed herein. In some examples, aspects of the operations of 2010 may be performed by a resource indication component 1330 as described with reference to FIG. 13.

At 2015, the method may include outputting a signal including an indication for the UE to use the other configuration based at least in part on the communication parameter being excluded from the subset of communication parameters. The operations of 2015 may be performed in accordance with examples as disclosed herein. In some examples, aspects of the operations of 2015 may be performed by a resource indication component 1330 as described with reference to FIG. 13.

At 2020, the method may include communicating with the UE in accordance with the communication parameter associated with the wireless communication and based at least in part on the other configuration. The operations of 2020 may be performed in accordance with examples as disclosed herein. In some examples, aspects of the operations of 2020 may be performed by a wireless communication component 1335 as described with reference to FIG. 13.

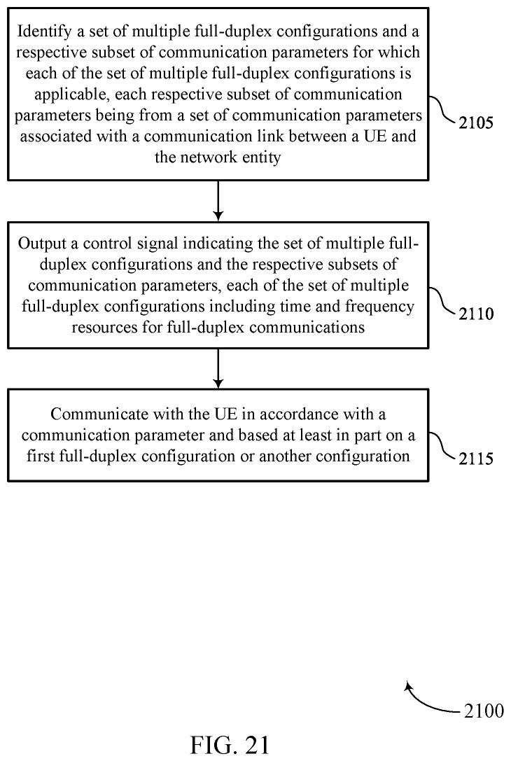

FIG. 21 shows a flowchart illustrating a method 2100 that supports beam-based full-duplex configurations in accordance with one or more aspects of the present disclosure. The operations of the method 2100 may be implemented by a network entity or its components as described herein. For example, the operations of the method 2100 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2105, the method may include identifying a set of multiple full-duplex configurations and a respective subset of communication parameters for which each of the set of multiple full-duplex configurations is applicable, each respective subset of communication parameters being from a set of communication parameters associated with a communication link between a UE and the network entity. The operations of 2105 may be performed in accordance with examples as disclosed herein. In some examples, aspects of the operations of 2105 may be performed by a resource configuration component 1340 as described with reference to FIG. 13.

At 2110, the method may include outputting a control signal indicating the set of multiple full-duplex configurations and the respective subsets of communication parameters, each of the set of multiple full-duplex configurations including time and frequency resources for full-duplex communications. The operations of 2110 may be performed in accordance with examples as disclosed herein. In some examples, aspects of the operations of 2110 may be performed by a resource indication component 1330 as described with reference to FIG. 13.

At 2115, the method may include communicating with the UE in accordance with a communication parameter and based at least in part on a first full-duplex configuration or another configuration. The operations of 2115 may be performed in accordance with examples as disclosed herein. In some examples, aspects of the operations of 2115 may be performed by a wireless communication component 1335 as described with reference to FIG. 13.

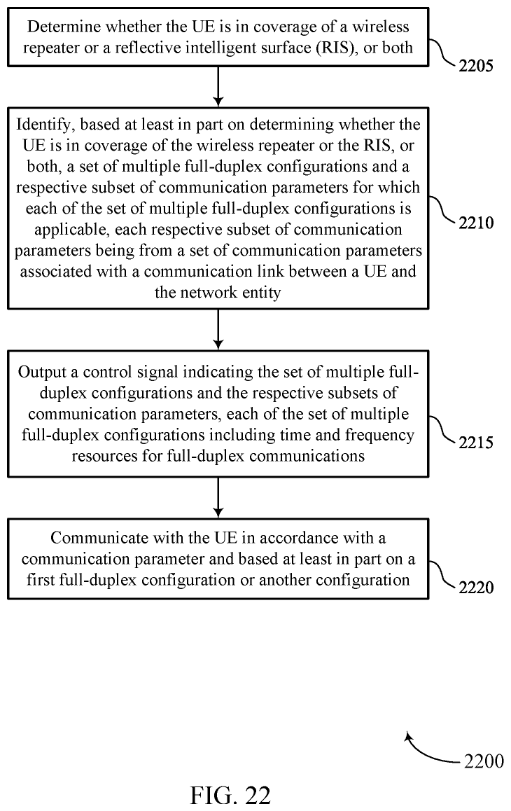

FIG. 22 shows a flowchart illustrating a method 2200 that supports beam-based full-duplex configurations in accordance with one or more aspects of the present disclosure. The operations of the method 2200 may be implemented by a network entity or its components as described herein. For example, the operations of the method 2200 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2205, the method may include determining whether the UE is in coverage of a wireless repeater or a RIS, or both. The operations of 2205 may be performed in accordance with examples as disclosed herein. In some examples, aspects of the operations of 2205 may be performed by a communication link component 1360 as described with reference to FIG. 13.

At 2210, the method may include identifying, based at least in part on determining whether the UE is in coverage of the wireless repeater or the RIS, or both, a set of multiple full-duplex configurations and a respective subset of communication parameters for which each of the set of multiple full-duplex configurations is applicable, each respective subset of communication parameters being from a set of communication parameters associated with a communication link between a UE and the network entity. The operations of 2210 may be performed in accordance with examples as disclosed herein. In some examples, aspects of the operations of 2210 may be performed by a resource configuration component 1340 as described with reference to FIG. 13.

At 2215, the method may include outputting a control signal indicating the set of multiple full-duplex configurations and the respective subsets of communication parameters, each of the set of multiple full-duplex configurations including time and frequency resources for full-duplex communications. The operations of 2215 may be performed in accordance with examples as disclosed herein. In some examples, aspects of the operations of 2215 may be performed by a resource indication component 1330 as described with reference to FIG. 13.

At 2220, the method may include communicating with the UE in accordance with a communication parameter and based at least in part on a first full-duplex configuration or another configuration. The operations of 2220 may be performed in accordance with examples as disclosed herein. In some examples, aspects of the operations of 2220 may be performed by a wireless communication component 1335 as described with reference to FIG. 13.

The following provides an overview of aspects of the present disclosure:

Aspect 1: A method for wireless communications at a UE, comprising: receiving a control signal indicating a full-duplex configuration for time and frequency resources for full-duplex communications, the control signal further indicating a subset of communication parameters for which the full-duplex configuration is applicable, wherein the subset of communication parameters is from a set of communication parameters respectively associated with a communication link between the UE and a network entity; determining whether to use the full-duplex configuration or another configuration for wireless communication with the network entity based at least in part on a communication parameter associated with the wireless communication and the subset of communication parameters associated with the full-duplex configuration; and communicating with the network entity in accordance with the communication parameter and based at least in part on the determining.

Aspect 2: The method of aspect 1, further comprising: receiving a signal comprising an indication to use the other configuration based at least in part on the communication parameter being excluded from the subset of communication parameters, wherein communicating with the network entity is based at least in part on the other configuration.

Aspect 3: The method of aspect 2, further comprising: dropping the full-duplex configuration based at least in part on the indication to use the other configuration.

Aspect 4: The method of any of aspects 2 through 3, wherein the signal comprises one of DCI, a RRC message, or a MAC-CE.

Aspect 5: The method of aspect 1, wherein the determining comprises: determining to use the other configuration based at least in part on the communication parameter being excluded from the subset of communication parameters, wherein communicating with the network entity is based at least in part on the other configuration.

Aspect 6: The method of aspect 5, further comprising: dropping the full-duplex configuration based at least in part on the communication parameter being excluded from the subset of communication parameters.

Aspect 7: The method of aspect 1, wherein the determining comprises: determining to use the full-duplex configuration for the wireless communication based at least in part on the communication parameter being included in the subset of communication parameters, wherein communicating with the network entity is based at least in part on the full-duplex configuration.

Aspect 8: The method of any of aspects 1 through 7, further comprising: determining that the time and frequency resources of the full-duplex configuration at least partially overlap with one or more channels, one or more reference signals, or any combination thereof, wherein determining whether to use the full-duplex configuration or the other configuration is further based at least in part on the time and frequency resources at least partially overlapping with the one or more channels, the one or more reference signals, or any combination thereof.

Aspect 9: The method of aspect 8, further comprising: dropping the full-duplex configuration based at least in part on the time and frequency resources at least partially overlapping with the one or more channels, the one or more reference signals, or any combination thereof, wherein communicating with the network entity is based at least in part on the other configuration.

Aspect 10: The method of any of aspects 8 through 9, further comprising: receiving a signal comprising an indication to use the other configuration based at least in part on the time and frequency resources at least partially overlapping with the one or more channels, the one or more reference signals, or any combination thereof; and dropping the full-duplex configuration based at least in part on the indication to use the other configuration, wherein communicating with the network entity is based at least in part on the other configuration.

Aspect 11: The method of aspect 10, wherein the signal comprising the indication is a second control signal configuring the one or more channels, a third control signal configuring the one or more reference signals, or any combination thereof.

Aspect 12: The method of any of aspects 8 through 11, wherein the one or more channels comprise a RACH, a RMSI PDCCH, an RMSI PDSCH, a paging PDCCH, a paging PDSCH, or any combination thereof.

Aspect 13: The method of any of aspects 1 through 12, wherein the UE is operating in a RRC inactive mode or a RRC idle mode, and the control signal comprises a system information signal.

Aspect 14: The method of any of aspects 1 through 13, wherein the UE is operating in a RRC active mode, and the control signal comprises a RRC message.

Aspect 15: The method of any of aspects 1 through 14, wherein the communication parameter comprises one or more beams, one or more signal thresholds associated with the one or more beams, a beam direction of the wireless communication, a geographic location of the UE, a downlink reception timing, an uplink transmission timing, a RTT of the wireless communication, one or more TAG identifiers, a type of communication link between the UE and the network entity, one or more outputs of a machine learning model, or any combination thereof.

Aspect 16: The method of aspect 15, wherein the beam direction of the wireless communication is associated with a synchronization signal block index, a downlink transmission configuration indicator state, an uplink transmission configuration indicator state, spatial relationship of one or more communication beams, or a combination thereof.

Aspect 17: The method of any of aspects 1 through 16, wherein the set of communication parameters comprise a set of zones, the method further comprising: receiving an indication that the UE is operating within a first zone of the set of zones, wherein determining whether to use the full-duplex configuration or the other configuration for the wireless communication is based at least in part on the indication that the UE is operating within the first zone.

Aspect 18: The method of any of aspects 1 through 17, wherein the communication parameter comprises a directional beam, the method further comprising: receiving a signal comprising an indication to use the other configuration based at least in part on the directional beam being excluded from a subset of directional beams associated with the full-duplex configuration; and dropping the full-duplex configuration based at least in part on the indication to use the other configuration, wherein communicating with the network entity is via the directional beam and based at least in part on the other configuration.

Aspect 19: The method of any of aspects 1 through 18, wherein the communication parameter comprises a directional beam, the method further comprising: determining to use the other configuration based at least in part on the directional beam being excluded from a subset of directional beams associated with the full-duplex configuration; and dropping the full-duplex configuration based at least in part on the directional beam being excluded from the subset of directional beams, wherein communicating with the network entity is via the directional beam and based at least in part on the other configuration.

Aspect 20: The method of aspect 19, further comprising: determining that a wireless repeater or a RIS, or both, is associated with the communication link between the UE and the network entity, wherein determining to use the other configuration is based at least in part on the wireless repeater or the RIS, or both, being associated with the communication link.

Aspect 21: The method of any of aspects 1 through 20, wherein the time and frequency resources associated with the full-duplex configuration comprise one or more subbands allocated for downlink communications and one or more subbands allocated for uplink communications.

Aspect 22: The method of any of aspects 1 through 21, wherein the communication parameter is excluded from the subset of communication parameters based at least in part on a wireless repeater or a RIS, or both, being associated with the communication link between the UE and the network entity, determining whether to use the full-duplex configuration or the other configuration is based at least in part on the wireless repeater or the RIS, or both, being associated with the communication link between the UE and the network entity.

Aspect 23: A method for wireless communications at a UE, comprising: receiving a control signal indicating a plurality of full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity; identifying, from the plurality of full-duplex configurations, a first full-duplex configuration for wireless communication with the network entity based at least in part on a communication parameter associated with the wireless communication being included in a first subset of communication parameters corresponding to the first full-duplex configuration; and communicating with the network entity in accordance with the communication parameter and based at least in part on the first full-duplex configuration or another configuration.

Aspect 24: The method of aspect 23, further comprising: receiving a signal comprising an indication to use the first full-duplex configuration based at least in part on the communication parameter associated with the wireless communication being included in the first subset of communication parameters, wherein identifying the first full-duplex configuration is based at least in part on the indication to use the first full-duplex configuration.

Aspect 25: The method of aspect 24, wherein the signal includes an index of the first full-duplex configuration, an identifier associated with the first full-duplex configuration, or both.

Aspect 26: The method of any of aspects 24 through 25, wherein the signal is one of a RRC message, DCI, or a MAC-CE.

Aspect 27: The method of any of aspects 23 through 26, further comprising: determining that the respective time and frequency resources of the first full-duplex configuration at least partially overlap with one or more channels, one or more reference signals, or any combination thereof; and determining whether to use the first full-duplex configuration or the other configuration based at least in part on the respective time and frequency resources at least partially overlapping with the one or more channels, the one or more reference signals, or any combination thereof.

Aspect 28: The method of aspect 27, further comprising: dropping the first full-duplex configuration based at least in part on the respective time and frequency resources at least partially overlapping with the one or more channels, the one or more reference signals, or any combination thereof, wherein communicating with the network entity is based at least in part on the other configuration.

Aspect 29: The method of aspect 27, further comprising: receiving a signal comprising an indication to use the other configuration based at least in part on the respective time and frequency resources at least partially overlapping with the one or more channels, the one or more reference signals, or any combination thereof; and dropping the first full-duplex configuration based at least in part on the indication to use the other configuration, wherein communicating with the network entity is based at least in part on the other configuration.

Aspect 30: The method of aspect 29, wherein the signal comprising the indication is a second control signal configuring the one or more channels, a third control signal configuring the one or more reference signals, or any combination thereof.

Aspect 31: The method of any of aspects 27 through 30, wherein the one or more channels comprise a RACH, a RMSI PDCCH, an RMSI PDSCH, a paging PDCCH, a paging PDSCH, or any combination thereof.

Aspect 32: The method of any of aspects 23 through 31, wherein the UE is operating in a RRC inactive mode or a RRC idle mode, and the control signal comprises a system information block.

Aspect 33: The method of any of aspects 23 through 32, wherein the UE is operating in a RRC active mode, and the control signal comprises a RRC message.

Aspect 34: The method of any of aspects 23 through 33, wherein the communication parameter comprises one or more beams, one or more signal thresholds associated with the one or more beams, a beam direction of the wireless communication, a geographic location of the UE, a downlink reception timing, an uplink transmission timing, a RTT of the wireless communication, one or more TAG identifiers, a type of communication link between the UE and the network entity, one or more outputs of a machine learning model, or any combination thereof.

Aspect 35: The method of aspect 34, wherein the beam direction of the wireless communication is associated with a synchronization signal block index, a downlink transmission configuration indicator state, an uplink transmission configuration indicator state, a spatial relations of one or more communication beams, or a combination thereof.

Aspect 36: The method of any of aspects 23 through 35, wherein the set of communication parameters comprise a set of zones, the method further comprising: receiving an indication that the UE is operating within a first zone of the set of zones, wherein determining whether to use the first full-duplex configuration or the other configuration for the wireless communication is based at least in part on the indication.

Aspect 37: The method of any of aspects 23 through 36, wherein the communication parameter comprises a directional beam, the method further comprising: receiving a signal comprising an indication to use the first full-duplex configuration based at least in part on the directional beam being included in a subset of directional beams associated with the first full-duplex configuration, wherein communicating with the network entity is via the directional beam and based at least in part on the first full-duplex configuration.

Aspect 38: The method of any of aspects 23 through 37, wherein the communication parameter comprises a directional beam, the method further comprising: determining to use the first full-duplex configuration based at least in part on the directional beam being included in a subset of directional beams associated with the first full-duplex configuration, wherein communicating with the network entity is via the directional beam and based at least in part on the first full-duplex configuration.

Aspect 39: The method of aspect 38, further comprising: determining that a wireless repeater or a RIS, or both, is associated with the communication link between the UE and the network entity, wherein determining to use the first full-duplex configuration is based at least in part on the wireless repeater or the RIS, or both, being associated with the communication link.

Aspect 40: The method of any of aspects 23 through 39, wherein the time and frequency resources associated with the full-duplex configuration comprise one or more subbands allocated for downlink communications and one or more subbands allocated for uplink communications.

Aspect 41: A method for wireless communications at a network entity, comprising: identifying a subset of communication parameters for which a full-duplex configuration is applicable for wireless communication between a UE and the network entity, the subset of communication parameters being from a set of communication parameters respectively associated with a communication link between the UE and the network entity; outputting a control signal indicating the full-duplex configuration and the subset of communication parameters, wherein the full-duplex configuration indicates time and frequency resources for full-duplex communications; and communicating with the UE in accordance with a communication parameter associated with the wireless communication and based at least in part on the full-duplex configuration or another configuration.

Aspect 42: The method of aspect 41, further comprising: outputting a signal comprising an indication for the UE to use the other configuration based at least in part on the communication parameter being excluded from the subset of communication parameters, wherein communicating with the UE is based at least in part on the other configuration.

Aspect 43: The method of aspect 42, wherein the signal is one of DCI, a RRC message, or MAC-CE.

Aspect 44: The method of aspect 41, wherein the communicating comprises: communicating with the UE according to the full-duplex configuration based at least in part on the communication parameter being included in the subset of communication parameters.

Aspect 45: The method of aspect 41, wherein the communicating further comprises: communicating with the UE according to the other configuration based at least in part on the time and frequency resources of the full-duplex configuration at least partially overlapping with one or more channels, one or more reference signals, or any combination thereof.

Aspect 46: The method of aspect 45, further comprising: outputting a signal comprising an indication to use the other configuration based at least in part on the time and frequency resources of the full-duplex configuration at least partially overlapping with the one or more channels, the one or more reference signals, or any combination thereof.

Aspect 47: The method of aspect 46, wherein the signal comprising the indication is a second control signal configuring the one or more channels, a third control signal configuring the one or more reference signals, or any combination thereof.

Aspect 48: The method of any of aspects 45 through 47, wherein the one or more channels comprise a RACH, a RMSI PDCCH, an RMSI PDSCH, a paging PDCCH, a paging PDSCH, or any combination thereof.

Aspect 49: The method of any of aspects 41 through 48, wherein the UE is operating in a RRC inactive mode or a RRC idle mode, and the control signal comprises a system information signal.

Aspect 50: The method of any of aspects 41 through 49, wherein the UE is operating in a RRC active mode, and the control signal comprises a RRC message.

Aspect 51: The method of any of aspects 41 through 50, wherein the communication parameter comprises one or more beams, one or more signal threshold associated with the one or more beams, a beam direction of the wireless communication, a geographic location of the UE, a downlink reception timing, an uplink transmission timing, a RTT of the wireless communication, one or more TAG identifiers, a type of communication link between the UE and the network entity, one or more outputs of a machine learning model, or any combination thereof.

Aspect 52: The method of aspect 51, wherein the beam direction of the wireless communication is associated with a synchronization signal block index, a downlink transmission configuration indicator state, an uplink transmission configuration indicator state, a spatial relations of one or more communication beams, or a combination thereof.

Aspect 53: The method of any of aspects 41 through 52, wherein the set of communication parameters are a set of zones, the method further comprising: outputting an indication that the UE is operating within a first zone of the set of zones, wherein communicating with the UE is based at least in part on the indication that the UE is operating within the first zone.

Aspect 54: The method of any of aspects 41 through 53, further comprising: determining whether the UE is in coverage of a wireless repeater or a RIS, or both, wherein identifying the subset of communication parameters is based at least in part on determining whether the UE is in coverage of the wireless repeater or the RIS, or both.

Aspect 55: The method of any of aspects 41 through 54, wherein the time and frequency resources associated with the full-duplex configuration comprise one or more subbands allocated for downlink communications and one or more subbands allocated for uplink communications.

Aspect 56: A method for wireless communications at a network entity, comprising: identifying a plurality of full-duplex configurations and a respective subset of communication parameters for which each of the plurality of full-duplex configurations is applicable, each respective subset of communication parameters being from a set of communication parameters associated with a communication link between a UE and the network entity; outputting a control signal indicating the plurality of full-duplex configurations and the respective subsets of communication parameters, each of the plurality of full-duplex configurations comprising time and frequency resources for full-duplex communications; and communicating with the UE in accordance with a communication parameter and based at least in part on a first full-duplex configuration or another configuration.

Aspect 57: The method of aspect 56, further comprising: outputting a signal comprising an indication to use the first full-duplex configuration based at least in part on the communication parameter associated with a wireless communication being included in the first subset of communication parameters, wherein communicating the wireless communication is based at least in part on the indication to use the first full-duplex configuration.

Aspect 58: The method of aspect 57, wherein the signal includes an index of the first full-duplex configuration, an identifier associated with the first full-duplex configuration, or both.

Aspect 59: The method of any of aspects 57 through 58, wherein the signal is one of RRC message, DCI, or a MAC-CE.

Aspect 60: The method of aspect 56, wherein the communicating further comprises: communicating with the UE according to the other configuration based at least in part on respective time and frequency resources of the first full-duplex configuration at least partially overlapping with one or more common channels, one or more reference signals, or any combination thereof.

Aspect 61: The method of aspect 60, further comprising: outputting a signal comprising an indication to use the other configuration for a wireless communication based at least in part on the time and frequency resources of the first full-duplex configuration overlapping with the one or more common channels, the one or more reference signals, or any combination thereof.

Aspect 62: The method of aspect 61, wherein the signal comprising the indication is a second control signal configuring the one or more common channels, a third control signal configuring the one or more reference signals, or any combination thereof.

Aspect 63: The method of any of aspects 60 through 62, wherein the one or more common channels comprise a RACH, a PDCCH, an PDSCH, a paging PDCCH, a paging PDSCH, or any combination thereof.

Aspect 64: The method of any of aspects 56 through 63, wherein the UE is operating in a RRC inactive mode or a RRC idle mode, and the control signal comprises a system information block.

Aspect 65: The method of any of aspects 56 through 64, wherein the UE is operating in a RRC active mode, and the control signal comprises a RRC message.

Aspect 66: The method of any of aspects 56 through 65, wherein the communication parameter comprises one or more beams, one or more signal threshold associated with the one or more beams, a beam direction of a wireless communication, a geographic location of the UE, a downlink reception timing, an uplink transmission timing, a RTT of the wireless communication, one or more TAG identifiers, a type of communication link between the UE and the network entity, one or more outputs of a machine learning model, or any combination thereof.

Aspect 67: The method of aspect 66, wherein the beam direction of the wireless communication comprises a synchronization signal block index, a downlink transmission configuration indicator state, an uplink transmission configuration indicator state, a spatial relations of one or more communication beams, or a combination thereof.

Aspect 68: The method of any of aspects 56 through 67, wherein the set of communication parameters are a set of zones, the method further comprising: outputting an indication that the UE is operating within a first zone of the set of zones, wherein communicating with the UE is based at least in part on the indication.

Aspect 69: The method of any of aspects 56 through 68, further comprising: determining whether the UE is in coverage of a wireless repeater or a RIS, or both, wherein identifying the plurality of full-duplex configurations is based at least in part on determining whether the UE is in coverage of the wireless repeater or the RIS, or both.

Aspect 70: The method of any of aspects 56 through 69, wherein respective time and frequency resources associated with the full-duplex configuration comprise one or more subbands allocated for downlink communications and one or more subbands allocated for uplink communications.

Aspect 71: A UE for wireless communications, comprising one or more memories storing processor-executable code, and one or more processors coupled with the one or more memories and individually or collectively operable to execute the code to cause the UE to perform a method of any of aspects 1 through 22.

Aspect 72: A UE for wireless communications, comprising at least one means for performing a method of any of aspects 1 through 22.

Aspect 73: A non-transitory computer-readable medium storing code for wireless communications, the code comprising instructions executable by one or more processors to perform a method of any of aspects 1 through 22.

Aspect 74: A UE for wireless communications, comprising one or more memories storing processor-executable code, and one or more processors coupled with the one or more memories and individually or collectively operable to execute the code to cause the UE to perform a method of any of aspects 23 through 40.

Aspect 75: A UE for wireless communications, comprising at least one means for performing a method of any of aspects 23 through 40.

Aspect 76: A non-transitory computer-readable medium storing code for wireless communications, the code comprising instructions executable by one or more processors to perform a method of any of aspects 23 through 40.

Aspect 77: A network entity for wireless communications, comprising one or more memories storing processor-executable code, and one or more processors coupled with the one or more memories and individually or collectively operable to execute the code to cause the network entity to perform a method of any of aspects 41 through 55.

Aspect 78: A network entity for wireless communications, comprising at least one means for performing a method of any of aspects 41 through 55.

Aspect 79: A non-transitory computer-readable medium storing code for wireless communications, the code comprising instructions executable by one or more processors to perform a method of any of aspects 41 through 55.

Aspect 80: A network entity for wireless communications, comprising one or more memories storing processor-executable code, and one or more processors coupled with the one or more memories and individually or collectively operable to execute the code to cause the network entity to perform a method of any of aspects 56 through 70.

Aspect 81: A network entity for wireless communications, comprising at least one means for performing a method of any of aspects 56 through 70.

Aspect 82: A non-transitory computer-readable medium storing code for wireless communications, the code comprising instructions executable by one or more processors to perform a method of any of aspects 56 through 70.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations. Components within a wireless communication system may be coupled (for example, operatively, communicatively, functionally, electronically, and/or electrically) to each other.

The functions described herein may be implemented using hardware, software executed by a processor or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, for example, A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control signal indicating a full-duplex configuration for time and frequency resources for full-duplex communications, the control signal further indicating a subset of communication parameters for which the full-duplex configuration is applicable, wherein the subset of communication parameters is from a set of communication parameters respectively associated with a communication link between the UE and a network entity;
determine whether to use the full-duplex configuration or another configuration for wireless communication with the network entity based at least in part on a communication parameter associated with the wireless communication and the subset of communication parameters associated with the full-duplex configuration; and
communicate with the network entity in accordance with the communication parameter and based at least in part on the determining.

2. The UE of claim 1, wherein the one or more processors are individually or collectively further operable to execute the code to cause the UE to:
receive a signal comprising an indication to use the other configuration based at least in part on the communication parameter being excluded from the subset of communication parameters, wherein communicating with the network entity is based at least in part on the other configuration.

3. The UE of claim 2, wherein the one or more processors are individually or collectively further operable to execute the code to cause the UE to:
drop the full-duplex configuration based at least in part on the indication to use the other configuration.

4. The UE of claim 2, wherein the signal comprises one of downlink control information, a radio resource control message, or a medium access control-control element.

5. The UE of claim 1, wherein, to determine, the one or more processors are individually or collectively operable to execute the code to cause the UE to:
determine to use the other configuration based at least in part on the communication parameter being excluded from the subset of communication parameters, wherein communicating with the network entity is based at least in part on the other configuration.

6. The UE of claim 5, wherein the one or more processors are individually or collectively further operable to execute the code to cause the UE to:
drop the full-duplex configuration based at least in part on the communication parameter being excluded from the subset of communication parameters.

7. The UE of claim 1, wherein, to determine, the one or more processors are individually or collectively operable to execute the code to cause the UE to:
determine to use the full-duplex configuration for the wireless communication based at least in part on the communication parameter being included in the subset of communication parameters, wherein communicating with the network entity is based at least in part on the full-duplex configuration.

8. The UE of claim 1, wherein the one or more processors are individually or collectively further operable to execute the code to cause the UE to:
determine that the time and frequency resources of the full-duplex configuration at least partially overlap with one or more channels, one or more reference signals, or any combination thereof, wherein determining whether to use the full-duplex configuration or the other configuration is further based at least in part on the time and frequency resources at least partially overlapping with the one or more channels, the one or more reference signals, or any combination thereof.

9. The UE of claim 8, wherein the one or more processors are individually or collectively further operable to execute the code to cause the UE to:
drop the full-duplex configuration based at least in part on the time and frequency resources at least partially overlapping with the one or more channels, the one or more reference signals, or any combination thereof, wherein communicating with the network entity is based at least in part on the other configuration.

10. The UE of claim 8, wherein the one or more processors are individually or collectively further operable to execute the code to cause the UE to:
receive a signal comprising an indication to use the other configuration based at least in part on the time and frequency resources at least partially overlapping with the one or more channels, the one or more reference signals, or any combination thereof; and
drop the full-duplex configuration based at least in part on the indication to use the other configuration, wherein communicating with the network entity is based at least in part on the other configuration.

11. The UE of claim 10, wherein the signal comprising the indication is a second control signal configuring the one or more channels, a third control signal configuring the one or more reference signals, or any combination thereof.

12. The UE of claim 8, wherein the one or more channels comprise a random access channel (RACH), a remaining minimum system information (RMSI) physical downlink control channel (PDCCH), an RMSI physical downlink shared channel (PDSCH), a paging PDCCH, a paging PDSCH, or any combination thereof.

13. The UE of claim 1, wherein the UE is operating in a radio resource control inactive mode or a radio resource control idle mode, and the control signal comprises a system information signal.

14. The UE of claim 1, wherein the UE is operating in a radio resource control active mode, and the control signal comprises a radio resource control message.

15. The UE of claim 1, wherein the communication parameter comprises one or more beams, one or more signal thresholds associated with the one or more beams, a beam direction of the wireless communication, a geographic location of the UE, a downlink reception timing, an uplink transmission timing, a round-trip-time of the wireless communication, one or more timing advance group (TAG) identifiers, a type of the communication link between the UE and the network entity, one or more outputs of a machine learning model, or any combination thereof.

16. The UE of claim 15, wherein the beam direction of the wireless communication is associated with a synchronization signal block index, a downlink transmission configuration indicator state, an uplink transmission configuration indicator state, spatial relationship of one or more communication beams, or a combination thereof.

17. The UE of claim 1, wherein the set of communication parameters comprise a set of zones, and the one or more processors are individually or collectively further operable to execute the code to cause the UE to:
receive an indication that the UE is operating within a first zone of the set of zones, wherein determining whether to use the full-duplex configuration or the other configuration for the wireless communication is based at least in part on the indication that the UE is operating within the first zone.

18. A user equipment (UE), comprising:
one or more memories storing processor-executable code; and
one or more processors coupled with the one or more memories and individually or collectively operable to execute the code to cause the UE to:
receive a control signal indicating a plurality of full-duplex configurations, each full-duplex configuration indicating respective time and frequency resources used for full-duplex communications and further indicating a respective subset of communication parameters for which each full-duplex configuration is applicable, the respective subsets of communication parameters being from a set of communication parameters respectively associated with a communication link between the UE and a network entity;
identify, from the plurality of full-duplex configurations, a first full-duplex configuration for wireless communication with the network entity based at least in part on a communication parameter associated with the wireless communication being included in a first subset of communication parameters corresponding to the first full-duplex configuration; and
communicate with the network entity in accordance with the communication parameter and based at least in part on the first full-duplex configuration or another configuration.

19. The UE of claim 18, wherein the one or more processors are individually or collectively further operable to execute the code to cause the UE to:
receive a signal comprising an indication to use the first full-duplex configuration based at least in part on the communication parameter associated with the wireless communication being included in the first subset of communication parameters, wherein identifying the first full-duplex configuration is based at least in part on the indication to use the first full-duplex configuration.

20. The UE of claim 19, wherein the signal includes an index of the first full-duplex configuration, an identifier associated with the first full-duplex configuration, or both.

21. The UE of claim 19, wherein the signal is one of a radio resource control message, downlink control information, or a medium access control-control element.

22. The UE of claim 18, wherein the one or more processors are individually or collectively further operable to execute the code to cause the UE to:
determine that the respective time and frequency resources of the first full-duplex configuration at least partially overlap with one or more channels, one or more reference signals, or any combination thereof; and
determine whether to use the first full-duplex configuration or the other configuration based at least in part on the respective time and frequency resources at least partially overlapping with the one or more channels, the one or more reference signals, or any combination thereof.

23. The UE of claim 22, wherein the one or more processors are individually or collectively further operable to execute the code to cause the UE to:
drop the first full-duplex configuration based at least in part on the respective time and frequency resources at least partially overlapping with the one or more channels, the one or more reference signals, or any combination thereof, wherein communicating with the network entity is based at least in part on the other configuration.

24. The UE of claim 22, wherein the one or more processors are individually or collectively further operable to execute the code to cause the UE to:
receive a signal comprising an indication to use the other configuration based at least in part on the respective time and frequency resources at least partially overlapping with the one or more channels, the one or more reference signals, or any combination thereof; and
drop the first full-duplex configuration based at least in part on the indication to use the other configuration, wherein communicating with the network entity is based at least in part on the other configuration.

25. The UE of claim 24, wherein the signal comprising the indication is a second control signal configuring the one or more channels, a third control signal configuring the one or more reference signals, or any combination thereof.

26. The UE of claim 22, wherein the one or more channels comprise a random access channel (RACH), a remaining minimum system information (RMSI) physical downlink control channel (PDCCH), an RMSI physical downlink shared channel (PDSCH), a paging PDCCH, a paging PDSCH, or any combination thereof.

27. The UE of claim 18, wherein the UE is operating in a radio resource control inactive mode or a radio resource control idle mode, and the control signal comprises a system information block.

28. The UE of claim 18, wherein the UE is operating in a radio resource control active mode, and the control signal comprises a radio resource control message.

29. A network entity, comprising:
one or more memories storing processor-executable code; and
one or more processors coupled with the one or more memories and individually or collectively operable to execute the code to cause the network entity to:
identify a subset of communication parameters for which a full-duplex configuration is applicable for wireless communication between a user equipment (UE) and the network entity, the subset of communication parameters being from a set of communication parameters respectively associated with a communication link between the UE and the network entity;
output a control signal indicating the full-duplex configuration and the subset of communication parameters, wherein the full-duplex configuration indicates time and frequency resources for full-duplex communications; and
communicate with the UE in accordance with a communication parameter associated with the wireless communication and based at least in part on the full-duplex configuration or another configuration.

30. A network entity, comprising:
one or more memories storing processor-executable code; and
one or more processors coupled with the one or more memories and individually or collectively operable to execute the code to cause the network entity to:
identify a plurality of full-duplex configurations and a respective subset of communication parameters for which each of the plurality of full-duplex configurations is applicable, each respective subset of communication parameters being from a set of communication parameters associated with a communication link between a user equipment (UE) and the network entity;
output a control signal indicating the plurality of full-duplex configurations and the respective subsets of communication parameters, each of the plurality of full-duplex configurations comprising time and frequency resources for full-duplex communications; and
communicate with the UE in accordance with a communication parameter and based at least in part on a first full-duplex configuration or another configuration.
